(19) United States
(12) Patent Application Publication
(10) Pub. No.: US 2026/0218722 A1
(43) Pub. Date: Jul. 30, 2026

(54) VOLUTE, FAN AND AIR CONDITIONER

(71) Applicants: GD MIDEA AIR-CONDITIONING EQUIPMENT CO., LTD., Foshan (CN); MIDEA GROUP WUHAN HEATING & VENTILATING EQUIPMENT CO., LTD., Wuhan (CN); MIDEA GROUP CO., LTD., Foshan (CN)

(72) Inventors: Guangwei RONG, Foshan (CN); Yong ZENG, Foshan (CN); Junwen PANG, Foshan (CN); Meng XU, Foshan (CN); Jie YANG, Foshan (CN); Feng WANG, Foshan (CN); Yang YAO, Foshan (CN)

(21) Appl. No.: 19/145,326

(22) PCT Filed: Jun. 14, 2023
(86) PCT No.: PCT/CN2023/100134

§ 371 Date: Jul. 2, 2025

(30) Foreign Application Priority Data
Jan. 3, 2023 (CN) 202310003556.5
Jan. 3, 2023 (CN) 202310003978.2
Jan. 3, 2023 (CN) 202310004206.0
Jan. 3, 2023 (CN) 202320005318.3
Jan. 3, 2023 (CN) 202320005933.4
Jan. 3, 2023 (CN) 202320006020.4

(51) Int. Cl. F04D 29/42; F04D 17/02; F04D 29/28; F04D 29/66

(52) U.S. Cl. CPC F04D 29/4233; F04D 17/02; F04D 29/281; F04D 29/667

(57) ABSTRACT

A volute, a fan, an air conditioner, and a blade structure. The volute (123-10) includes: an enclosing plate (1-100), which encloses an air duct (1-101); an end plate (1-200) connected to an end of the enclosing plate (1-100), the end plate (1-200) being formed with an air intake (1-201) and a convex surface (1-202) which is arranged around the air inlet (1-201); an convex surface (1-202) located at a side of the end plate (1-200) away from the air duct (1101), the convex surface (1-202) extending from the enclosing plate (1-100) toward the air inlet (1-201).

### CROSS-REFERENCE TO RELATED APPLICATIONS

This application claims priority to Chinese patent application Nos. 202310003556.5, 202310003978.2, 202310004206.0, 202320005318.3, 202320005933.4 and 202320006020.4 filed on Jan. 3, 2023, the entire contents of all of which are incorporated herein by reference.

### TECHNICAL FIELD

The disclosure relates to the technical field of air-conditioning equipment, and in particular to a volute, a fan, and an air conditioner.

### BACKGROUND

With continuously increased demands on the air supply performance of air-conditioning equipment, more and more attention is focused on the static pressure performance level of fans. The fans are showing a trend of developing towards high static pressure and high air volume. However, in actual applications, some fans will generate severe noises during operation, which seriously affects a sensory experience of users during use and results in a poor user experience of product.

### SUMMARY

The disclosure aims to solve at least one of the technical problems existing in the prior art or related technology and provides a volute, a fan, and an air conditioner.

According to a first aspect of the disclosure, a volute is provided, including: an enclosing plate enclosing an air duct; an end plate connected to an end of the enclosing plate. The end plate forms an air inlet and a convex surface which is arranged around the air inlet. The convex surface is located at a side of the end plate away from the air duct. The convex surface extends from the enclosing plate toward the air inlet.

According to a second aspect of the disclosure, a fan is provided, comprising: a volute as described above; and an impeller rotatably disposed in an air duct, the impeller being disposed toward an air inlet.

According to a third aspect of the disclosure, an air conditioner is provided, comprising: the fan as described above.

### BRIEF DESCRIPTION OF DRAWINGS

Various additional advantages and benefits will become apparent to those skilled in the art from a reading of the following detailed description of exemplary embodiments. The accompanying drawings are only for purposes of illustrating exemplary embodiments and are not to be considered limiting of the disclosure. Also, throughout the accompanying drawings, the same reference symbols are used to denote the same components. In the accompanying drawings:

FIG. 1 is a schematic structural diagram of a volute according to some embodiments of the disclosure;

FIG. 2 is a schematic structural cross-sectional diagram of the volute according to some embodiments of the disclosure;

FIG. 3 is a schematic structural cross-sectional view of an end plate of the volute according to some embodiments of the disclosure;

FIG. 4 is a schematic structural diagram of a fan from a first viewing angle according to some embodiments of the disclosure;

FIG. 5 is a schematic diagram of the fan from a second viewing angle according to some embodiments of the disclosure;

FIG. 6 is a schematic structural diagram of the fan from a third viewing angle according to some embodiments of the disclosure;

FIG. 7 is a schematic structural diagram of a blade structure according to some embodiments of the disclosure;

FIG. 8 is a schematic diagram of usage scenario of the blade structure according to some embodiments of the disclosure;

FIG. 9 is a schematic partial enlarged view of a region indicated by A in FIG. 8;

FIG. 10 is a schematic diagram of using effect of the blade structure according to some embodiments of the disclosure;

FIG. 11 is a schematic structural diagram of an impeller of the fan from a first viewing angle according to some embodiments of the disclosure;

FIG. 12 is a schematic structural diagram of the impeller of the fan from a second viewing angle according to some embodiments of the disclosure;

FIG. 13 is a schematic structural diagram of the impeller of the fan from a third viewing angle according to some embodiments of the disclosure;

FIG. 14 is a schematic structural diagram of a fan from a first viewing angle according to some embodiments of the disclosure;

FIG. 15 is a schematic structural diagram of the impeller from a second viewing angle according to some embodiments of the disclosure;

FIG. 16 is a schematic structural diagram of a blade structure from a first viewing angle according to some embodiments of the disclosure;

FIG. 17 is a schematic diagram of the blade structure from a second viewing angle according to some embodiments of the disclosure;

FIG. 18 is a schematic cross-sectional view of the blade structure taken along A-A direction shown in FIG. 17;

FIG. 19 is a schematic diagram of application scenario of the blade structure according to some embodiments of the disclosure;

FIG. 20 is a schematic partial enlarged view of a region indicated by B in FIG. 19;

FIG. 21 is a schematic structural diagram of an impeller from a first viewing angle according to some embodiments of the disclosure;

FIG. 22 is a schematic structural diagram of the impeller from a second viewing angle according to some embodiments of the disclosure;

FIG. 23 is a schematic cross-sectional view of the impeller taken along C-C direction shown in FIG. 22;

FIG. 24 is a schematic structural diagram of a hub according to some embodiments of the disclosure;

FIG. 25 is a schematic structural diagram of a hoop according to some embodiments of the disclosure;

FIG. 26 is a schematic structural diagram of a fan from a first viewing angle according to some embodiments of the disclosure; and

FIG. 27 is a schematic diagram of the fan from a second viewing angle according to some embodiments of the disclosure.

In the accompanying drawings, corresponding relationships between reference signs and component names are as follows:
123-10, volute; 123-20, impeller; 23-100, blade structure; 23-200, hub; 23-300, hoop; 23-400, sleeve; 23-101, blade centerline;
1-100, enclosing plate; 1-200, end plate; 1-300, air outlet guide; 1-110, first plate-shaped member; 1-210, first guide section; 1-220, second guide section; 1-230, transition section; 1-260, second plate-shaped member; 1-270, fastening member; 1-101, air duct; 1-201, air inlet; 1-202, convex surface; 1-301, air outlet; 1-2101, first curved surface section; 1-2201, second curved surface section; 1-2301, transition curved surface section;
2-102, leading edge end curve; 2-103, outlet end line; 2-104, positive pressure surface curve; 2-105, negative pressure surface curve; 2-106, outlet transition line;
3-110, fastening structure; 3-201, first mounting hole; 3-301, second mounting hole; 3-1011, conic curve segment; 3-1012, straight line segment.

### DETAILED DESCRIPTION

Exemplary embodiments of the disclosure will be described in more detail below with reference to the accompanying drawings. Although exemplary embodiments of the disclosure are shown in the accompanying drawings, it should be understood that the disclosure can be implemented in various forms and should not be limited to the embodiments set forth herein. On the contrary, these embodiments are provided to enable a more thorough understanding of the disclosure and to fully convey the scope of the disclosure to those skilled in the art.

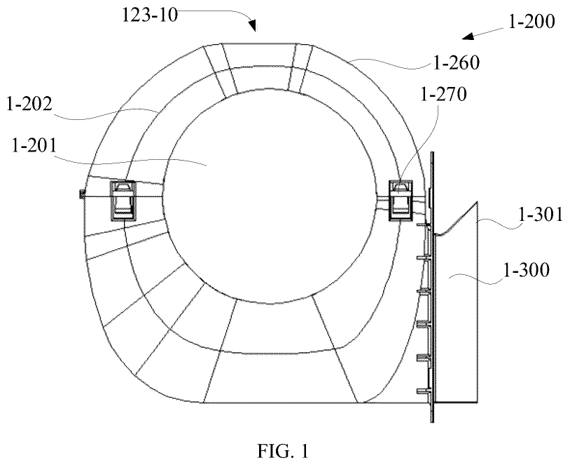

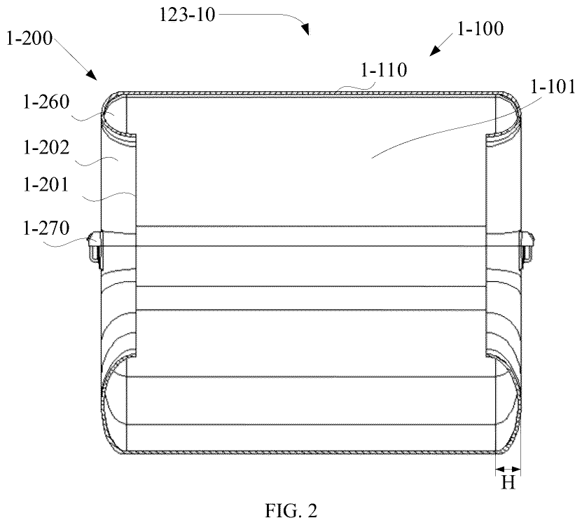

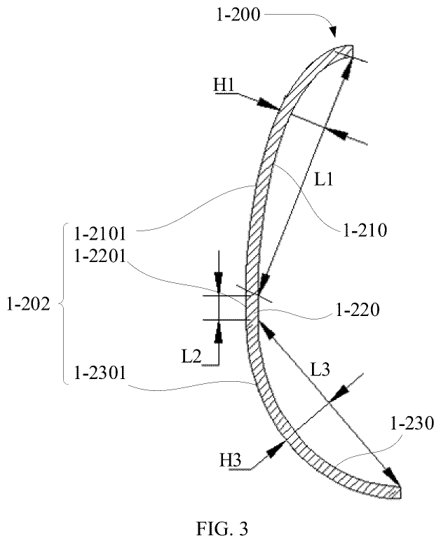

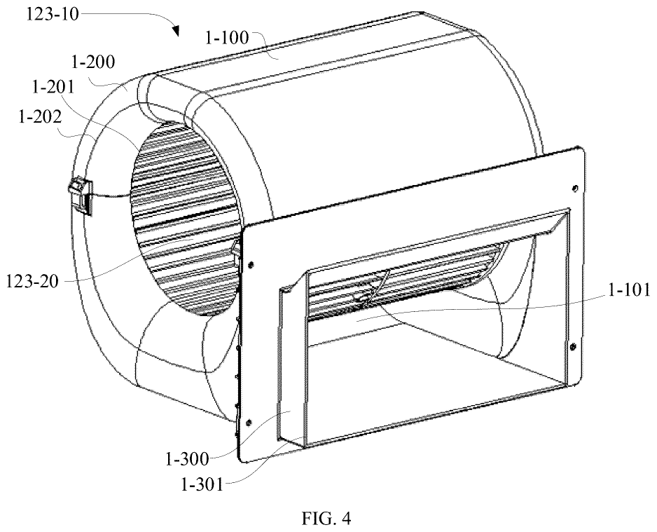

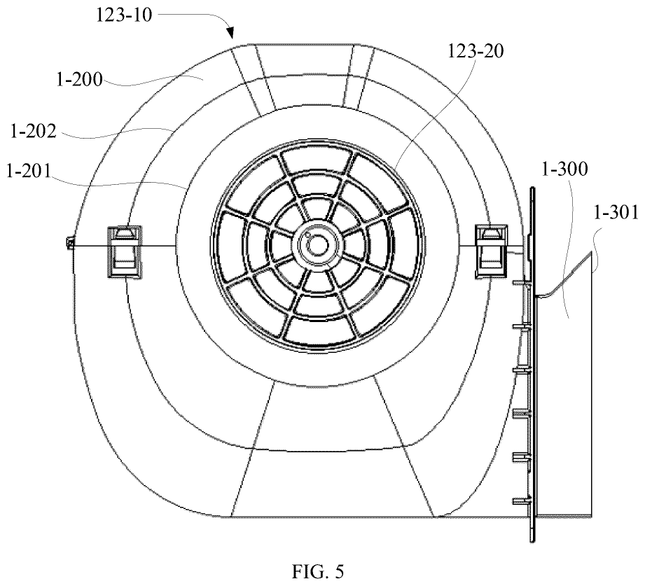

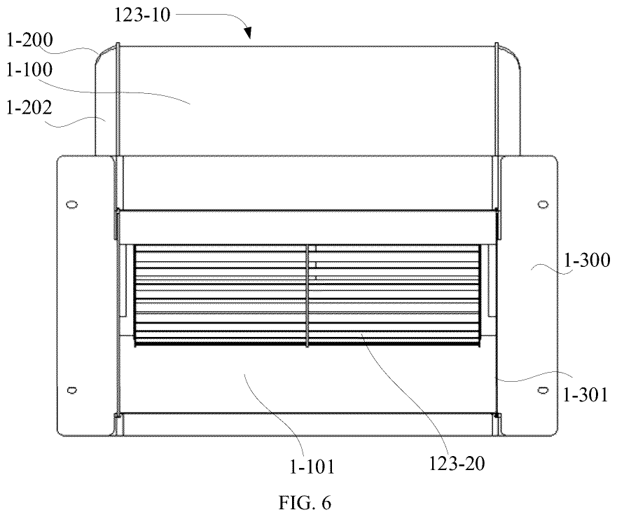

FIG. 1 is a schematic structural diagram of a volute according to some embodiments of the disclosure; FIG. 2 is a schematic structural cross-sectional diagram of the volute according to some embodiments of the disclosure; FIG. 3 is a schematic structural cross-sectional view of an end plate of the volute according to some embodiments of the disclosure; FIG. 4 is a schematic structural diagram of a fan from a first viewing angle according to some embodiments of the disclosure; FIG. 5 is a schematic diagram of the fan from a second viewing angle according to some embodiments of the disclosure; and FIG. 6 is a schematic structural diagram of the fan from a third viewing angle according to some embodiments of the disclosure.

In a first aspect of the disclosure, a volute is provided. As shown in FIGS. 1 to 6, the volute 123-10 according to some embodiments of the disclosure includes: an enclosing plate 1-100, which encloses an air duct 1-101; an end plate 1-200, which is connected to an end of the enclosing plate 1-100. The end plate 1-200 forms an air inlet 1-201 and a convex surface 1-202 which is arranged around the air inlet 1-201. The convex surface 1-202 is located at a side of the end plate 1-200 away from the air duct 1-101. The convex surface 1-202 is extended from the enclosing plate 1-100 toward the air inlet 1-201.

According to some embodiments of the disclosure, the volute 123-10 may include an enclosing plate 1-100 and an end plate 1-200. The enclosing plate 1-100 encloses an air duct 1-101. The end plate 1-200 is connected to an end of the enclosing plate 1-100, and forms an air inlet 1-201 and a convex surface 1-202. The convex surface 1-202 is arranged around the air inlet 1-201, and is located at a side of the end plate 1-200 away from the air duct 1-101. The convex surface 1-202 is extended from the enclosing plate 1-100 toward the air inlet 1-201. In some embodiments, the volute 123-10 can be used as a component of a fan. An impeller 123-20 of the fan can be rotatably disposed in the air duct 1-101. The impeller 123-20 can be disposed toward the air inlet 1-201. Based on the above-mentioned disposition of the volute 123-10, in actual application, when the impeller 123-20 rotates, a gas outside the volute 123-10 can be introduced into the air duct 1-101 through the air inlet 1-201. In a process of the gas outside the volute 123-10 flowing to the impeller 123-20, the gas in an area near the end plate 1-200 can flow along the convex surface 1-202. Since the convex surface 1-202 extends toward the air inlet 1-201, the convex surface 1-202 can have a flowing guide effect on a gas flowing to the impeller 123-20, and can adjust an attack angle of the gas when the gas flows to the impeller 123-20, to change an inflow condition of the gas when the gas enters the volute 123-10, to be conducive to making the gas to more smoothly flow to the impeller 123-20, weakening an impact of the gas on an air inlet end of the impeller 123-20, and in turn reducing an operating noise generated by the fan during use and improving a user experience of product.

In some embodiments, the relatively dispersed gas distributed outside the volute 123-10 can be continuously gathered in a process of flowing along the convex surface 1-202, and form, when flowing to the impeller 123-20, a highly concentrated airflow. An axial direction of the impeller 123-20 can be consistent with an extending-through direction of the air inlet 1-201, and thus the airflow, when flowing to the impeller 123-20 through the air inlet 1-201, can be easier to move a longer distance along the axial direction of the impeller 123-20. In this way, a distribution width of the airflow in the axial direction of the impeller 123-20 can be increased, an overall speed of the airflow after flowing out of the blades of the impeller 123-20 can be reduced, and a recirculation phenomenon at an air outlet end of the impeller 123-20 can be reduced, to be conductive to reducing a gas impact at an air inlet end of the impeller 123-20, thereby reducing the operating noise of the fan.

It should be noted that, as shown in FIGS. 1, 4 and 5, the enclosing plate 1-100 may be a plate-shaped structure extending in a spiral form to enclose the air duct 1-101. An opening is formed at an axial end of the enclosing plate 1-100. The end plate 1-200 may be connected to the axial end of the enclosing plate 1-100 to cover the opening. The air inlet 1-201 formed on the end plate 1-200 is in communication with the air duct 1-101. An extending-through direction of the air inlet 1-201 may be consistent with the axial direction of the enclosing plate 1-100. In actual applications, an axial end of the impeller 123-20 may be disposed toward the air inlet 1-201. The air duct 1-101 is located in a circumferential direction of the impeller 123-20, and thus when the impeller 123-20 rotates, an external gas is introduced through the air inlet 1-201, and is discharged to the air duct 1-101, to make the gas to be accelerated and pressurized in the air duct 1-101.

It should be noted that, as shown in FIG. 2, the end plate 1-200 may protrude relative to the enclosing plate 1-100 along the axial direction of the enclosing plate 1-100, to form the convex surface 1-202 at a side of the end plate 1-200 away from the air duct 1-101. It can be understood that at least a portion of the convex surface 1-202 may protrude relative to an end of the enclosing plate 1-100 along the axial direction of the enclosing plate 1-100. As shown in FIG. 1, along a radial direction of the air inlet 1-201, an end of the convex surface 1-202 is connected to the enclosing plate 1-100, that is, an outer edge of the convex surface 1-202 is connected to an axial end of the enclosing plate 1-100, and another end of the convex surface 1-202, that is, an inner edge of the convex surface 1-202 is located at the air inlet 1-201. The convex surface 1-202 extends smoothly in a curve pattern between two ends thereof, and when the gas flows through the convex surface 1-202, the convex surface 1-202 can be used to guide the gas and improve the smoothness of the gas when flowing, to weaken an impact of the gas on an air inlet end of the impeller 123-20 and in turn reduce the operating noise generated by the fan when in use.

It can be understood that, as shown in FIG. 3, the two ends of the convex surface 1-202 extend smoothly in the curve pattern, that is, in a cross-section of the end plate 1-200 parallel to a direction of the air inlet 1-201, a contour of the convex surface 1-202 is a curve. The curve may be a curve in a pattern of a continuous circular arc or elliptical arc or hyperbolic segment or parabolic segment or the like; or, the curve may be composed of a plurality of line segments connected in sequence, at least one of the plurality of line segments being a curve segment. Exemplarily, as shown in FIG. 3, the curve is composed of three line segments connected in sequence. Two curve segments are connected by a straight line segment. It should be noted that, in a condition that the curve is composed of a plurality of line segments connected in sequence, the line segment close to the air inlet 1-201 is a curve segment, and a smooth transition is disposed between two adjacent line segments.

It should be noted that, as shown in FIG. 2, the convex surface 1-202 and the enclosing plate 1-100 can have a smooth transition therebetween, to be capable of improving the smoothness of the gas when flowing through a junction of the enclosing plate 1-100 and the convex surface 1-202, reducing a possibility of the gas forming a local vortex at the junction, facilitating improvement in an air intake efficiency of the fan, and reducing a possibility of generating strong noise in an area near the end plate 1-200.

It should be noted that, as shown in FIG. 2, the number of end plates 1-200 may be two. Two end plates 1-200 are respectively connected to the two ends of the enclosing plate 1-100, and thus in actual applications, the gas outside the volute 123-10 can enter the air duct 1-101 through the air inlets 1-201 on the two end plates 1-200, to improve the air intake efficiency of the fan. In a condition that an extending-through direction of the air inlet 1-201 is consistent with an axial direction of the impeller 123-20, the gas can flow from two axial ends of the impeller 123-20 into the impeller 123-20, to be advantageous to further increasing a distribution width of an airflow in the axial direction of the impeller 123-20, to be capable of reducing an overall speed of the airflow after flowing out of the blades of the impeller 123-20, reducing a recirculation phenomenon at an air outlet end of the impeller 123-20, and in turn reducing a gas impact at an air inlet end of the impeller 123-20 to reduce an operating noise of the fan.

As shown in FIG. 3, in some embodiments, the end plate 1-200 may include a first guide section 1-210, and a second guide section 1-220 which is connected to the first guide section 1-210. An end of the first guide section 1-210 is connected to the enclosing plate 1-100. Another end of the first guide section 1-210 is extended towards the air inlet 1-201. The first guide section 1-210 is formed with a first curved surface section 1-2101 at a side away from the air duct 1-101. The air inlet 1-201 is formed at the second guide section 1-220. The second guide section 1-220 is formed with a second curved surface section 1-2201 at a side away from the air duct 1-101. The second curved surface section 1-2201 is extended towards an inner side of the enclosing plate 1-100. The convex surface 1-202 may include a first curved surface section 1-2101 and a second curved surface section 1-2201.

In some embodiments, the end plate 1-200 may include a first guide section 1-210 and a second guide section 1-220. Two ends of the first guide section 1-210 are respectively connected to the enclosing plate 1-100 and the second guide section 1-220. The second guide section 1-220 is formed with the air inlet 1-201 to facilitate an introduction of gas outside the volute 123-10 through the air inlet 1-201 in actual applications.

The first guide section 1-210 and the second guide section 1-220 are respectively formed with a first curved surface section 1-2101 and a second curved surface section 1-2201 at a side away from the air duct 1-101. The convex surface 1-202 includes the first curved surface section 1-2101 and the second curved surface section 1-2201. Based on a disposition of the first guide section 1-210, an end of the first curved surface section 1-2101 can be connected to the enclosing plate 1-100, and another end of the first curved surface section 1-2101 can be connected to the second curved surface section 1-2201. Therefore, based on the disposition of the first curved surface section 1-2101, it is convenient to use the first curved surface section 1-2101 to guide a flowing direction of a gas near a junction of the end plate 1-200 and the enclosing plate 1-100 in actual applications, and thus the gas can approach the air inlet 1-201 more smoothly, to reduce a possibility of forming a local vortex in an area near the junction, to be conducive for improving the air intake efficiency of the fan and reducing the operating noise of the fan. It can be understood that the air duct 1-101 is formed on an inner side of the enclosing plate 1-100, and by extending the second curved surface section 1-2201 towards the inner side of the enclosing plate 1-100, it is convenient for the gas to be smoothly guided to the air inlet 1-201 and introduced into the air duct 1-101 by the second curved surface section 1-2201. The attack angle of the gas when flowing to the impeller 123-20 can be adjusted, and an inflow condition of the gas when entering the volute 123-10 can be changed, to be advantageous to making the gas to flow to the impeller 123-20 more smoothly, weakening the gas impact on the air inlet end of the impeller 123-20, and in turn reducing the operating noise generated by the fan during use and improving the user experience of product.

It should be noted that, as shown in FIG. 3, in a cross-section of the end plate 1-200 parallel to a direction of the air inlet 1-201, a contour of the first guide segment 1-210 may be a first curve segment, which can be but not limited to a circular-arc segment or an elliptical arc segment or a parabolic segment or a hyperbolic segment, etc. In the cross-section of the end plate 1-200 parallel to the direction of the air inlet 1-201, a contour of the second guide segment 1-220 may be a second curve segment, which can be but not limited to a circular-arc segment or an elliptical arc segment or a parabolic segment or a hyperbolic segment, etc. The first curve segment and the second curve segment may be the same type of curves. In some embodiments, the first curve segment and the second curve segment may be both elliptical arcs, to facilitate a smooth transition between the first curved surface section 1-2101 and the second curved surface section 1-2201. The first curve segment and the second curve segment may also be different types of curves. In an embodiment, the first curve segment is a circular arc, and the second curve segment is an elliptical arc, to facilitate widening a range of curvature variation of the convex surface 1-202, to enhance a flowing guide effect of the convex surface 1-202 on the gas.

It can be understood that the first guide section 1-210 and the second guide section 1-220 may be directly connected, and accordingly, the first curved section 1-2101 and the second curved section 1-2201 may be directly connected. It may also be that other guide sections may also be disposed between the first guide section 1-210 and the second guide section 1-220 to connect the first guide section 1-210 and the second guide section 1-220 through other guide sections, and accordingly, the first curved section 1-2101 and the second curved section 1-2201 may also be indirectly connected, to facilitate an improvement of a transition smoothness between the first guide section 1-210 and the second guide section 1-220 and an improvement of a transition smoothness between the first curved section 1-2101 and the second curved section 1-2201. This is conducive to further improving a guide effect on the gas. In actual applications, the gas impact on the air inlet end of the impeller 123-20 can be reduced, to further reduce the operating noise generated by the fan.

As shown in FIG. 3, in some embodiments, the end plate 1-200 may also include: a transition section 1-230 which is connected between the first guide section 1-210 and the second guide section 1-220. The transition section 1-230 is formed with a transition curved surface section 1-2301 at a side away from the air duct 1-101. Two ends of the transition curved surface section 1-2301 are respectively connected to the first curved surface section 1-2101 and the second curved surface section 1-2201. The first curved surface section 1-2101 and the second curved surface section 1-2201 each have a smooth transition with the transition curved surface section 1-2301. The convex surface 1-202 may also include the transition curved surface section 1-2301.

In some embodiments, the end plate 1-200 may further include a transition section 1-230 connected between the first guide section 1-210 and the second guide section 1-220, and thus the first guide section 1-210 can be indirectly connected to the second guide section 1-220 through the transition section 1-230. The transition section 1-230 is formed with a transition curved surface section 1-2301 at a side away from the air duct 1-101. The first curved surface section 1-2101 and the second curved surface section 1-2201 can be connected through the transition curved surface section 1-2301. The first curved surface section 1-2101 and the second curved surface section 1-2201 each can have smooth transitions with the transition curved surface section 1-2301. Therefore based on the above disposition, the first curved surface section 1-2101 and the second curved surface section 1-2201 can transition more smoothly, and thus in a process of gas flowing along the convex surface 1-202, excessive changes on a flowing direction of the gas can be prevented to reduce a possibility of occurrence of gas-wall separation phenomenon, and reduce losses of airflow while a smoothness of flowing of gas is improved and the operating noise of the fan is reduced. This is advantageous to improving an air intake efficiency of the fan, increasing an air volume of the fan, and in turn improving a static pressure and air volume performance of the fan.

It should be noted that the number of transition sections 1-230 may be more than one. A plurality of transition sections 1-230 are connected in sequence. At least one transition section 1-230 is connected to the first guide section 1-210, and at least one transition section 1-230 is connected to the second guide section 1-220. The transition curved surface section 1-2301 of the transition section 1-230 which is connected to the first guide section 1-210 smoothly transitions with the first curved surface section 1-2101. The transition curved surface section 1-2301, which is connected to the transition section 1-230 of the second guide section 1-220, smoothly transitions with the second curved surface section 1-2201. Adjacent transition surface sections 1-2301 have a smooth transition therebetween. Therefore, based on the disposition of the plurality of transition sections 1-230, a smoothness of the convex surface 1-202 can be further improved, to be capable of enhancing a flowing guide effect of the convex surface 1-202 on the gas. This is conducive to further reducing an impact of the gas on an air inlet end of the impeller 123-20, and in turn reducing an operating noise of the fan and improving a user experience of product.

It can be understood that the smooth transition indicates that a curvature of a junction between two adjacent curved surface sections is continuous.

As shown in FIG. 3, in some embodiments, a ratio of a chord height to a chord length of each of curved surface sections is less than or equal to 0.5.

In some embodiments, a ratio of a chord height to a chord length of each curved surface section may be set to be less than or equal to 0.5. It can be understood that the curved surface sections refer to the first curved surface section 1-2101, the transition curved surface section 1-2301, and the second curved surface section 1-2201. As shown in FIG. 3, in a cross section of the end plate 1-200 parallel to a direction of the air inlet 1-201, a contour of the curved surface sections are curve segments. A chord height of each curved surface section refers to a chord height of the curve segment corresponding to the curved surface section. The chord length refers to a chord length of the curve segment corresponding to the curved surface section. Therefore, based on the above-mentioned settings, a curvature degree of each curved surface section in the extending-through direction of the air inlet 1-201 can be constrained to avoid excessive curvature degree of each curved surface section, and in turn in a process of gas flowing along the convex surface 1-202, to be capable of preventing the gas from having excessively changed flowing direction, reducing a possibility of occurrence of gas-wall separation phenomenon, to be capable of reducing the losses of airflow while improving a smoothness of flowing of gas and reducing the operating noise of the fan. This is advantageous to improving the air intake efficiency of the fan, increasing the air volume of the fan, and in turn improving the static pressure and air volume performance of the fan.

It should be noted that a ratio of a chord height H1 to a chord length L1 of the first curved surface section 1-2101 is greater than 0, and a ratio of a chord height H3 to a chord length L3 of the second curved surface section 1-2201 is greater than 0, to ensure that the first curved surface section 1-2101 and the second curved surface section 1-2201 have a certain curvature degree, and in turn in actual applications, a flowing guide effect of a gas near the first curved surface section 1-2101 and the second curved surface section 1-2201 can be guaranteed. A ratio of a chord height to a chord length L2 of the transition curved surface section 1-2301 may be greater than or equal to 0. As shown in FIG. 3, in a condition that the ratio of the chord height to the chord length L2 of the transition curved surface section 1-2301 is equal to 0, the transition curved surface section 1-2301 is a plane, and two ends of the transition curved surface section 1-2301 are tangent to the first curved surface section 1-2101 and the second curved surface section 1-2201 respectively, to ensure that the first curved surface section 1-2101 and the second curved surface section 1-2201 both have a smooth transition with the transition curved surface section 1-2301, that is, the transition curved surface section 1-2301 may be a plane to reduce a change amplitude of flowing direction of the gas when flowing through the transition curved surface section 1-2301, to reduce losses of airflow.

As shown in FIG. 2, in some embodiments, along an extending-through direction of the air inlet 1-201, a protrusion height H of the convex surface 1-202 is greater than or equal to 10 mm.

In some embodiments, along an extending-through direction of the air inlet 1-201, a protrusion height H of the convex surface 1-202 may be set to be greater than or equal to 10 mm. It can be understood that, as shown in FIG. 2, an end of the end plate 1-200 is connected to the enclosing plate 1-100, and thus an end of the convex surface 1-202 is also connected to the enclosing plate 1-100. The protrusion height H is also a maximum distance between the convex surface 1-202 and an end of the enclosing plate 1-100 along the extending-through direction of the air inlet 1-201. Based on the setting, it can be ensured that the convex surface 1-202 has a higher protrusion height, to be easy to increase the curvature degree of the convex surface 1-202, enhance a flowing guide effect of the convex surface 1-202 on the gas flowing to the impeller 123-20, adjust an attack angle of the gas when flowing to the impeller 123-20, and change an inflow condition of the gas when entering the volute 123-10, thereby facilitating the gas to flow to the impeller 123-20 more smoothly, weakening an impact of the gas on an air inlet end of the impeller 123-20, in turn reducing an operating noise generated by the fan during use and improving a user experience of product.

In some embodiments, along the extending-through direction of the air inlet 1-201, a protrusion height H of the convex surface 1-202 is greater than or equal to 10 mm, and less than or equal to 25 mm, to be capable of avoiding excessive curvature degree of the convex surface 1-202, to be advantageous to preventing the gas from having excessive changes of flowing direction and reducing a possibility of occurrence of gas-wall separation phenomenon. A losses of airflow can be reduced while a smoothness of gas flowing can also be improved, and an operating noise of the fan can be reduced, to be conducive for improving an air intake efficiency of the fan, increasing an air volume of the fan, and in turn improving a static pressure and air volume performance of the fan.

As shown in FIGS. 1 and 4 to 6, in some embodiments, the volute 123-10 may also include: an air outlet guide 1-300, which is formed with an air outlet 1-301 and an air outlet channel that are in communication with each other. The enclosing plate 1-100 is formed with an exhaust port in communication with the air duct 1-101. The air outlet guide 1-300 is disposed at the exhaust port. The air outlet channel is in communication with the air duct 1-101 through the exhaust port.

In some embodiments, the volute 123-10 may further include an air outlet guide 1-300. The enclosing plate 1-100 may be formed with an exhaust port. The exhaust port is in communication with the air duct 1-101, and thus the gas in the air duct 1-101 can be discharged through the exhaust port. The air outlet guide 1-300 is located at the exhaust port, and is formed with an air outlet 1-301 and an air outlet channel. The air outlet 1-301 is in communication with the air outlet channel. An end of the air outlet channel away from the air outlet 1-301 is in communication with the exhaust port, and thus the gas can flow into the air outlet channel through the exhaust port and flow out of the air outlet 1-301 under a constraint of the air outlet guide 1-300, to facilitate a realization of the external air supply of the fan in actual application. Based on a disposition of the air outlet guide 1-300, the volute 123-10 can guide a flowing of gas when the gas is discharged, to improve a smoothness of the gas flowing out of the volute 123-10 and improve an air outlet efficiency of the fan, being conducive for enhancing a static pressure and air volume performance of the fan, reducing a noise at the air outlet 1-301, and improving a user experience of product.

It can be understood that the air outlet guide 1-300 is connected to the enclosing plate 1-100. The air outlet guide 1-300 may be an integrated structure with the enclosing plate 1-100 to reduce a connection gap between the air outlet guide 1-300 and the enclosing plate 1-100 and improve a connection strength between the air outlet guide 1-300 and the enclosing plate 1-100. The air outlet guide 1-300 may also be connected to the enclosing plate 1-100 by threaded connection, riveting, welding or the like.

As shown in FIGS. 1 and 2, in some embodiments, the enclosing plate 1-100 may include at least two first plate-shaped members 1-110. The at least two first plate-shaped members 1-110 are connected in sequence along a circumferential direction of the air inlet 1-201 to enclose an air duct 1-101. The end plate 1-200 may include at least two second plate-shaped members 1-260. Each first plate-shaped member 1-110 is connected to one second plate-shaped member 1-260. Second plate-shaped members 1-260 may be formed with notches and at least two second plate-shaped members 1-260 may be connected, and thus at least two notches are interfaced with each other to form the air inlet 1-201.

In some embodiments, the enclosing plate 1-100 may include at least two first plate-shaped members 1-110. The end plate 1-200 may include at least two second plate-shaped members 1-260. The first plate-shaped members 1-110 are sequentially connected along a circumferential direction of the air inlet 1-201, to enclose the air duct 1-101. Each first plate-shaped member 1-110 is connected to one second plate-shaped member 1-260. Second plate-shaped member 1-260 are formed with notches. In a condition that at least two first plate-shaped members 1-110 are connected to each other, at least two corresponding second plate-shaped members 1-260 may be connected to each other, and thus at least two notches are interfaced with each other to form an air inlet 1-201. Based on the above disposition, the volute 123-10 can be modularized, and in turn in a process of manufacturing the volute 123-10, the at least two first plate-shaped members 1-110 and the at least two second plate-shaped members 1-260 can be processed separately, to reduce a difficulty of processing the enclosing plate 1-100 and the end plate 1-200. The first plate-shaped member 1-110 and the second plate-shaped member 1-260 can be assembled to form the volute 123-10 by way of assembly, being conducive for reducing a difficulty and cost of processing the volute 123-10 and improving a manufacturing efficiency of the volute 123-10.

It can be understood that, in a condition that the end plate 1-200 includes the first guide section 1-210 and the second guide section 1-220, each second plate-shaped member 1-260 may include a portion of the first guide section 1-210 and a portion of the second guide section 1-220, and thus at least two second plate-shaped members 1-260, when connected, can be interfaced with each other to form a complete first guide section 1-210 and a second guide section 1-220. In a similar way, in a condition that the end plate 1-200 includes the transition section 1-230, each second plate-shaped member 1-260 may include a portion of the transition section 1-230, and thus at least two second plate-shaped members 1-260, when connected, can be interfaced with each other to form a complete transition section 1-230.

In some embodiments, as shown in FIGS. 1 and 2, the volute 123-10 may also include a fastening member 1-270. The fastening member is disposed at the second plate-shaped member 1-260. Two adjacent second plate-shaped members 1-260 can be connected by the fastening member 1-270, to improve a connection strength between the two adjacent second plate-shaped members 1-260 and improve a structural stability and reliability of the volute 123-10. It can be understood that the fastening member 1-270 may include a buckle and a slot. The buckle is disposed at one of the two adjacent second plate-shaped members 1-260, and the slot is formed on another of the two adjacent second plate-shaped members 1-260. The buckle can be snapped into the slot to achieve a fastened connection between the two adjacent second plate-shaped members 1-260.

In some embodiments, the volute 123-10 may be a sheet metal volute or a plastic volute.

In some embodiments, the volute 123-10 may be a sheet metal volute. Sheet metal parts usually have good molding accuracy, to be convenient for forming the convex surface 1-202 with high dimensional accuracy at a side of the end plate 1-200 during a manufacturing process of the volute 123-10, and in turn to be capable of ensuring a flowing guide effect on the gas, improving an operating noise of the fan to which the volute belongs, and enhancing a user experience of product. In addition, the sheet metal volute can have a higher structural strength, to be advantageous to extending a service life of the volute and reducing a possibility of structural damage to the volute.

In some embodiments, the volute 123-10 may be a plastic volute. The plastic material has a good processing performance and is easy to be processed and shaped. The plastic volute can have a high surface accuracy, and thus it is conducive to forming a smoothly extended convex surface 1-202, thereby being capable of ensuring a flowing guide effect on the gas, alleviating an operating noise of the fan to which the volute 123-10 belongs, and enhancing a user experience of product. In addition, a density of the plastic volute is relatively low, and thus it is capable of improving a lightweight level of the volute 123-10 and the fan, and facilitating an assembly and installation of the fan in actual applications.

In some embodiments, the enclosing plate 1-100 and the end plate 1-200 may be an integrated structure.

In some embodiments, the enclosing plate 1-100 and the end plate 1-200 may be provided as an integrated structure. Therefore, in a process of manufacturing the volute 123-10, the enclosing plate 1-100 and the end plate 1-200 can be processed in an integrated molding manner. On the one hand, joints between the enclosing plate 1-100 and the end plate 1-200 can be reduced, and a possibility of gas circulating through the joints can be reduced, to be advantageous to improving an operating efficiency of the fan to which the volute 123-10 belongs, and further reducing an operating noise generated by the fan. On another hand, an assembly process of the volute 123-10 can also be simplified; a manufacturing efficiency of the volute 123-10 can be improved; and a processing cost and use cost of the volute 123-10 can be reduced.

It should be noted that, in a condition that the enclosing plate 1-100 may include at least two first plate-shaped members 1-110 and the end plate 1-200 includes at least two second plate-shaped members 1-260, the first plate-shaped member 1-110 and the second plate-shaped member 1-260 may be provided as an integrated structure, to be capable of reducing joints between the enclosing plate 1-100 and the end plate 1-200, and reducing a possibility of gas circulating through the joints, to be advantageous to improving an operating efficiency of the fan to which the volute 123-10 belongs, and to also simplify an assembly process of the volute 123-10, improve a manufacturing efficiency of the volute 123-10, and reduce a processing cost and use cost of the volute 123-10.

In a second aspect of the disclosure, a fan is provided. As shown in FIGS. 4 to 6, in some embodiments, the fan may include an impeller 1-20 and a volute 123-10. The impeller 123-20 is disposed in an air duct 1-101 of the volute 123-10, and can rotate relative to the volute 123-10. The impeller 123-20 is disposed toward an air inlet 1-201 of the volute 123-10. Therefore, when the impeller 123-20 rotates, a gas outside the volute 123-10 can be introduced into the air duct 1-101 through the air inlet 1-201. In a process of the gas outside the volute 123-10 flowing to the impeller 123-20, the gas in an area near the end plate 1-200 can flow along the convex surface 1-202. Since the convex surface 1-202 extends toward the air inlet 1-201, the convex surface 1-202 can have a flowing guide effect on a gas flowing to the impeller 123-20, and can adjust an attack angle of the gas when the gas flows to the impeller 123-20, to change an inflow condition of the gas when the gas enters the volute 123-10, thereby being conducive to making the gas to more smoothly flow to the impeller 123-20, weakening an impact of the gas on an air inlet end of the impeller 123-20, and in turn to reduce an operating noise generated by the fan during use and improve a user experience of product.

It should be noted that, as shown in FIGS. 1, 4 and 5, the enclosing plate 1-100 may be a plate-shaped structure extending in a spiral pattern to enclose the air duct 1-101. An opening is formed at an axial end of the enclosing plate 1-100. The end plate 1-200 may be connected to the axial end of the enclosing plate 1-100 to cover the opening. The air inlet 1-201 formed on the end plate 1-200 is in communication with the air duct 1-101. An extending-through direction of the air inlet 1-201 may be consistent with the axial direction of the enclosing plate 1-100. An axial end of the impeller 123-20 may be disposed toward the air inlet 1-201. The air duct 1-101 is located in a circumferential direction of the impeller 123-20, and thus when the impeller 123-20 rotates, an external gas is introduced through the air inlet 1-201, and is discharged to the air duct 1-101, to make the gas to be accelerated and pressurized in the air duct 1-101.

In some embodiments, the fan may further include a driving device. The driving device is connected to the impeller 123-20 for driving the impeller 123-20 to rotate, to facilitate an adjustment of a rotation speed of the impeller 123-20 by controlling operating parameters of the driving device, in turn achieving a regulation of parameters of air supply of the fan.

In some embodiments, the volute 123-10 may include an enclosing plate 1-100 and an end plate 1-200. The enclosing plate 1-100 encloses an air duct 1-101. The end plate 1-200 is connected to an end of the enclosing plate 1-100, and forms an air inlet 1-201 and a convex surface 1-202. The convex surface 1-202 is arranged around the air inlet 1-201, and is located at a side of the end plate 1-200 away from the air duct 1-101. The convex surface 1-202 extends from the enclosing plate 1-100 toward the air inlet 1-201. In some embodiments, the volute 123-10 can be used as a component of the fan. The impeller 123-20 of the fan can be rotatably disposed in the air duct 1-101. The impeller 123-20 can be disposed toward the air inlet 1-201. Based on the above-mentioned disposition of the volute 123-10, in actual application, when the impeller 123-20 rotates, a gas outside the volute 123-10 can be introduced into the air duct 1-101 through the air inlet 1-201. In a process of the gas outside the volute 123-10 flowing to the impeller 123-20, the gas in an area near the end plate 1-200 can flow along the convex surface 1-202. Since the convex surface 1-202 extends toward the air inlet 1-201, the convex surface 1-202 can have a flowing guide effect on a gas flowing to the impeller 123-20, and can adjust an attack angle of the gas when the gas flows to the impeller 123-20, to change an inflow condition of the gas when the gas enters the volute 123-10, to be conducive to making the gas to flow to the impeller 123-20 more smoothly, weakening an impact of the gas on an air inlet end of the impeller 123-20, and in turn an operating noise generated by the fan during use can be reduced and a user experience of product can be improved.

Since the fan provided by some embodiments of the disclosure may include a volute 123-10, the fan possesses all the advantageous effects of the volute 123-10, which will not be elaborated here.

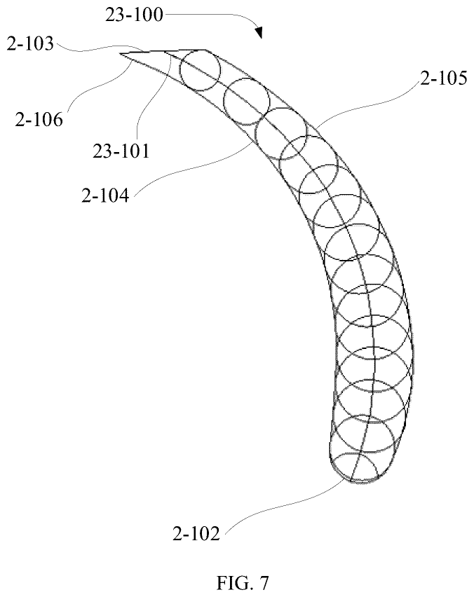

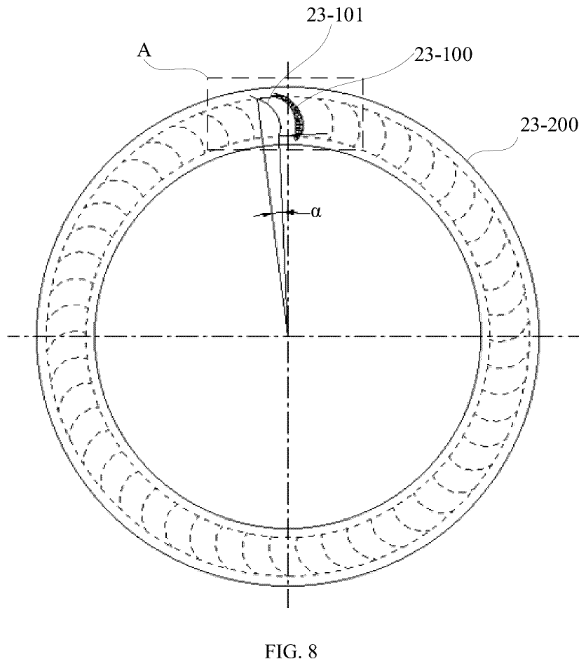

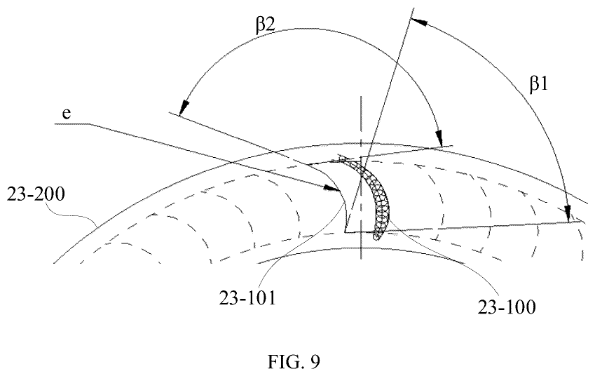

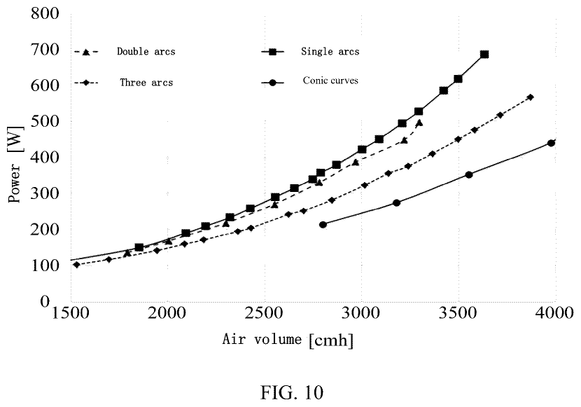

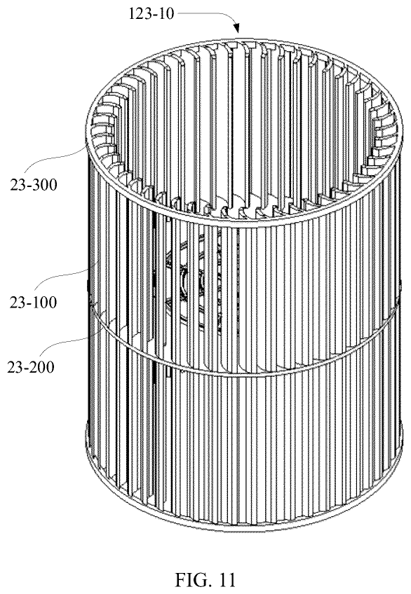

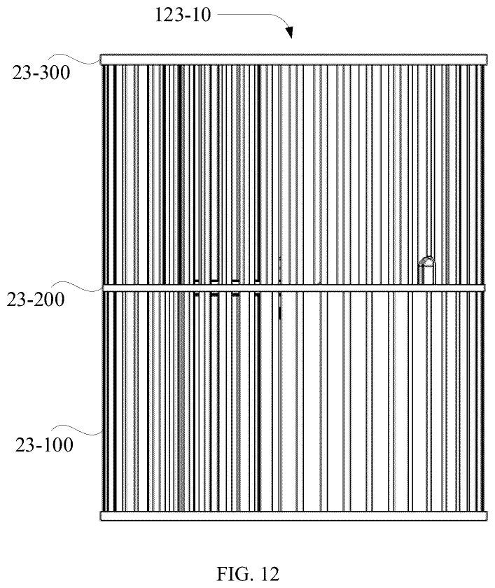

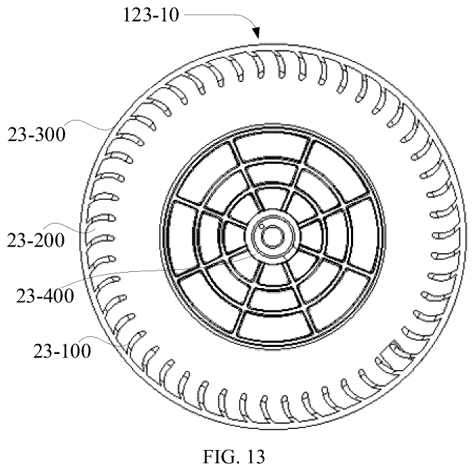

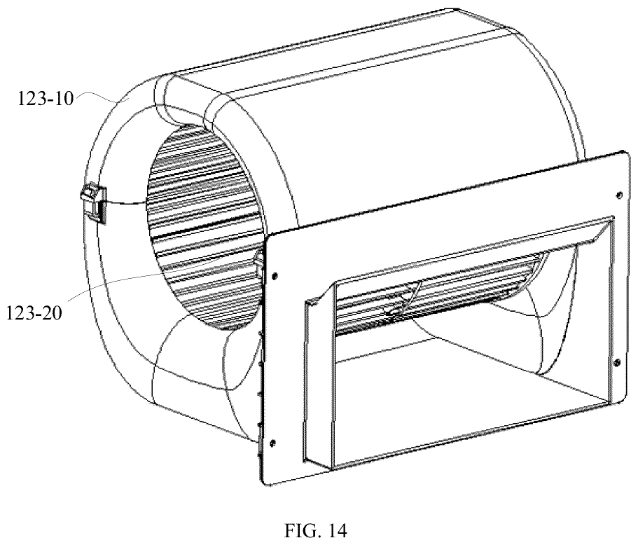

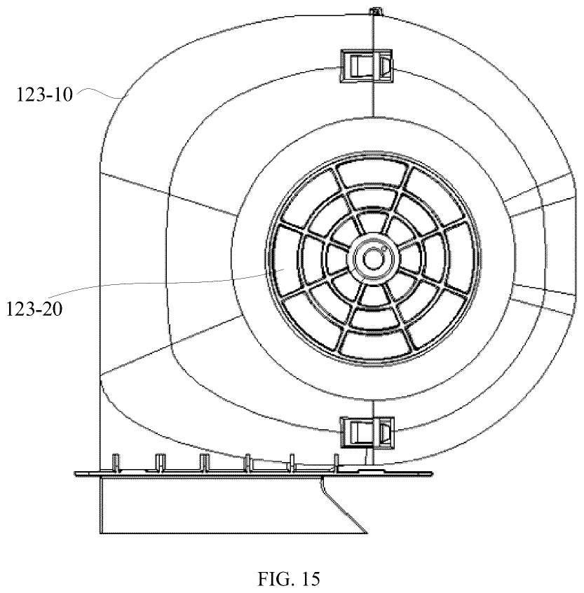

FIG. 7 is a schematic structural diagram of a blade structure according to some embodiments of the disclosure; FIG. 8 is a schematic diagram of usage scenario of the blade structure according to some embodiments of the disclosure; FIG. 9 is a schematic partial enlarged view of a region indicated by A in FIG. 8; FIG. 10 is a schematic diagram of using effect of the blade structure according to some embodiments of the disclosure; FIG. 11 is a schematic structural diagram of an impeller from a first viewing angle according to some embodiments of the disclosure; FIG. 12 is a schematic structural diagram of the impeller from a second viewing angle according to some embodiments of the disclosure; FIG. 13 is a schematic structural diagram of the impeller from a third viewing angle according to some embodiments of the disclosure; FIG. 14 is a schematic structural diagram of a fan from a first viewing angle according to some embodiments of the disclosure; FIG. 15 is a schematic structural diagram of the impeller from a second viewing angle according to some embodiments of the disclosure.

As shown in FIGS. 7 to 15, the impeller 123-20 of the fan provided according to some embodiments of the disclosure may include a hub 23-200; a blade structure 23-100, which is penetrated through the hub 23-200, and a plurality of the blade structures 23-100 are arranged at an interval along a circumferential direction of the hub 23-200; and a hoop 23-300, to which an end of the blade structure 23-100 is connected.

In some embodiments, the blade structure 23-100 is made of plastic. A blade centerline 23-101 of the blade structure 23-100 is a conic curve.

The blade centerline 23-101 of the blade structure 23-100 may be a conic curve. In actual applications, the blade structure 23-100 may be used as a component of the impeller 123-20 of the fan. For example, a plurality of blade structures 23-100 may be installed on the hub 23-200 of the impeller 123-20, to be convenient for various blades to follow a rotation of the hub 23-200, and in turn to be capable of driving a gas to flow to achieve air supply. Based on the above-mentioned settings, in actual applications, since the blade structure 23-100 can extend in a form of a conic curve as a whole, a curvature of the blade structure 23-100 can be changed in an extension direction, and thus in a process of gas flowing along the blade structure 23-100, it is more conducive to the blade structure 23-100 to do work on the gas, to be more conductive on effectively driving the gas to flow, to be conducive to reducing a gas flowing resistance, and in turn to be capable of improving an efficiency of the fan to which the blade belongs, reducing a power consumption of the fan, improving a static pressure capacity of the fan, reducing a possibility of fan stall, improving a performance of the fan, and increasing an air volume of the fan.

It can be understood that the blade centerline 23-101 of the blade structure 23-100 can also be called a blade profile line. As shown in FIG. 7, according to different usage requirements, a cross-section of the blade structure 23-100 usually extends along a specific curve. This curve is a profile line of blade, which is often called the blade centerline 23-101 or the blade profile line. A pattern of the blade centerline 23-101 usually directly affects an efficiency of the fan to which the blade structure 23-100 belongs.

It can be understood that a conic curve may generally include a hyperbola, a parabola or an elliptical arc. The blade centerline 23-101 of the blade structure 23-100 is a conic curve, that is, the blade centerline 23-101 of the blade structure 23-100 may be a hyperbola or a parabola or an elliptical arc. It is not difficult to understand that the blade structure 23-100 generally has a certain dimension, and accordingly, the blade centerline 23-101 can be a curve segment, that is, in some embodiments, the blade centerline 23-101 of the blade structure 23-100 may be a conic curve segment. If a rectangular coordinate system is established in a cross section of the blade structure 23-100, a general expression of the blade centerline 23-101 is as follows:

$$A \cdot {x}^{2} + B \cdot x \cdot y + C \cdot {y}^{2} + D \cdot x + E \cdot y + F = 0 \qquad ( 2 - 1 )$$

In formula (2-1), A, B, C, D, E and F are real numbers, and A≠0, B≠0, C≠0. It is understandable that when B\hat{ }2-4AC<0, the blade centerline 23-101 is an elliptical arc. When B\hat{ }2-4AC-0, the blade centerline 23-101 is a parabolic segment. When B\hat{ }2-4AC>0, the blade centerline 23-101 is a hyperbolic segment.

It should be noted that, in some embodiments, the blade centerlines of blades of fan are mostly an arc, and mostly are single arcs. It can be understood that a single-arc blade centerline also means that the blade centerline is composed of a continuous-arc shape, but in actual applications, the single-arc blade centerline has poor controllability, and it is difficult to achieve a significant improvement in an efficiency of fan by adjusting parameters of the blade centerline. Some blades of fan also have blade centerlines in a form of double arcs or multiple arcs. It can be understood that a double-arc blade centerline or a multi-arc blade centerline means that the blade centerline is composed of two or more connected arcs, but the double-arc blade centerline or multi-arc blade centerline has a discontinuous curvature at junctions of arcs. This is easy to cause a velocity loss of gas in actual applications, and thus an improvement on performance of the fan is also very limited.

Compared with the blade of fan with a circular-arc blade centerline 23-101, in some embodiments, the blade centerline 23-101 of the blade structure 23-100 is a conic curve. On one hand, a curvature of the blade structure 23-100 can be changed in an extension direction, and thus in a process of gas flowing along the blade structure 23-100, it is more conducive to the blade structure 23-100 to do work on the gas, to facilitate more effectively driving the gas to flow, thereby being conducive to reducing a gas flowing resistance, and in turn improving an efficiency of the fan to which the blade belongs, reducing a power consumption of the fan, improving a static pressure capacity of the fan, reducing a possibility of fan stall, improving a performance of the fan, and increasing an air volume of the fan. On another hand, it can also ensure a continuity of curvature of the blade structure 23-100, reduce a velocity loss during use, and be conducive to further increasing a maximum static pressure and air volume of the fan. In some embodiments, by deriving formula 1, formula (2-2) can be obtained:

$$\frac{dy}{dx} = - \frac{2 A \cdot x + C \cdot y + D}{2 B \cdot y + C \cdot x + E} \qquad ( 2 - 2 )$$

It can be seen from formula (2-2) that the blade centerline 23-101 of the blade structure 23-100 can maintain continuous curvature, and thus, compared with a double-arc or multi-arc blade centerline, a velocity loss can be reduced during use, to be advantageous to further increasing the maximum static pressure and air volume of the fan.

Exemplarily, as shown in Table 2-1 and FIG. 10, in table 2-1, an air volume-power consumption comparison diagram of a fan using different blade structures 23-100 is listed. It can be seen that in a condition that a same air volume is output, the fan using a blade structure 23-100 whose blade centerline 23-101 is a conic curve, can generate a smaller power consumption, and thus an efficiency of the fan is greatly improved. The blade structure 23-100 is conductive to increasing an air volume of the fan under a condition of equal energy consumption. In a process of increasing the air volume of the fan, since the blade structure 23-100, whose blade centerline 23-101 is a conic curve, can also ensure that a power consumption of the fan is at a relatively low level, it is reflected that the blade structure 23-100 can maintain its performance under higher air volume and static pressure, and thus a possibility of the fan stall phenomenon can be reduced, and a performance of the fan can be improved.

TABLE 2-1
Air volume-power consumption comparison

| | Power/W | | | |
|---|---|---|---|---|
| Air volume/cmh | Single arc | Double arcs | Three arcs | Conic curves |
| 2800 | 359 | 335 | 271 | 214 |
| 3200 | 490 | 437 | 365 | 278 |
| 3600 | 667 | — | 480 | 349 |
| 4000 | 883 | — | 608 | 453 |

The blade structure 23-100 may be made of plastic material. The plastic material has good processing properties, facilitating controlling a shaping of the blade structure 23-100 during a production process, and being capable of reducing a processing difficulty and processing cost of the blade structure 23-100. The blade structure 23-100 made of plastic material, after being shaped, can also have good structural strength, to be advantageous to saving a material cost while ensuring a service life of the blade structure 23-100.

In some embodiments, the blade structure 23-100 may be made of polypropylene or Acrylonitrile Butadiene Styrene copolymers (ABS) plastic or Acrylonitrile-Styrene copolymer (AS) plastic.

Formula (2-1) can be rewritten as formula (2-3):

$$\frac{- A}{F} \cdot {x}^{2} + \frac{- B}{F} \cdot x \cdot y + \frac{- C}{F} \cdot {y}^{2} + \frac{- D}{F} \cdot x + \frac{- B}{F} \cdot y = 1 \qquad ( 2 - 3 )$$

In some embodiments, an expression for a conic curve of a blade structure 23-100 may be determined by formula (2-3), and it can be set in formula (2-3) that, −A/F=−6.3732×10⁻⁵, −B/F=−5.5531×10⁻⁶, −C/F=−8.3930×10⁻⁵, −D/F=−1.9100×10⁻³, −E/F=−1.8491*×10⁻², where x is greater than or equal to 0 and less than or equal to 8.298, and y is greater than or equal to 104.135 and less than or equal to 124.999.

As shown in FIG. 7, in some embodiments, a cross-sectional contour of the blade structure 23-100 may include: a leading edge end curve 2-102. An end of the blade centerline 23-101 passes through the leading edge end curve 2-102. A ratio of an arch height of the leading edge end curve 2-102 to a chord length of the leading edge end curve 2-102 is greater than or equal to 0.3 and less than or equal to 0.8.

In some embodiments, a cross-sectional contour of the blade structure 23-100 may include a leading edge end curve 2-102. An end of the blade centerline 23-101 passes through the leading edge end curve 2-102. It can be understood that a pattern of the leading edge end curve 2-102 can affect a pattern of leading edge end surface of the blade structure 23-100. A leading edge end of the blade structure 23-100 is also an air inlet end in actual applications. Accordingly, an end of the blade centerline 23-101 passing through the leading edge end curve 2-102 is also an air inlet end of the blade centerline 23-101. By setting the ratio of the arch height to the chord length of the leading edge end curve 2-102 to be greater than or equal to 0.3 and less than or equal to 0.8, in actual applications, the impeller 123-20 to which the blade structure 23-100 belongs can provide a higher air volume and static pressure in a high efficiency range. Therefore, it is advantageous for the fan to exert performance. A power consumption of the fan can be reduced. A performance of the fan can be further improved. It is also advantageous to reducing a noise of the fan during use. A user perception of product can be improved. A user experience of product can be enhanced.

It can be understood that, as shown in FIG. 7, the leading edge end curve 2-102 is a convex curve. Two ends of the leading edge end curve 2-102 are respectively located on two sides of the blade centerline 23-101, that is, in actual application, the two ends of the leading edge end curve 2-102 are respectively located at a positive pressure side and a negative pressure side of the blade structure 23-100. When the blade drives the gas to flow, the gas will flow from an end where the leading edge end curve 2-102 is located to another end of the blade structure 23-100. Accordingly, an end of the blade structure 23-100 opposite to the leading edge curve 2-102 is an air outlet end of the blade structure 23-100, and an end of the blade centerline 23-101 away from the leading edge curve 2-102 is an air outlet end of the blade centerline 23-101. A chord length of the leading edge curve 2-102 is also a length of a line connecting two end points of the leading edge curve 2-102. An arch height of the leading edge curve 2-102 is also a maximum vertical distance from the leading edge curve 2-102 to a line of the chord length.

In some embodiments, the leading edge end curve 2-102 may be, but be not limited to, a circular arc, an elliptical arc, a hyperbola, or a parabola.

In some embodiments, a ratio of an arch height of the leading edge end curve 2-102 to a chord length of the leading edge end curve 2-102 may be equal to 0.6.

As shown in FIG. 7, in some embodiments, a cross-sectional contour of the blade structure 23-100 may also include: an outlet end line 2-103, through which an end of the blade centerline 23-101 away from the leading edge end curve 2-102 passes; a positive pressure surface curve 2-104, which is located at a side of the blade centerline 23-101, two ends of the positive pressure surface curve 2-104 being respectively connected to the leading edge end curve 2-102 and the outlet end line 2-103; a negative pressure surface curve 2-105, which is located at another side of the blade centerline 23-101, two ends of the negative pressure surface curve 2-105 being respectively connected to the leading edge end curve 2-102 and the outlet end line 2-103. The positive pressure surface curve 2-104 and the negative pressure surface curve 2-105 are both streamlined curves.

In some embodiments, a cross-sectional contour of the blade structure 23-100 may also include an outlet end line 2-103, a positive pressure surface curve 2-104, and a negative pressure surface curve 2-105. A segment of the blade centerline 23-101 away from the leading edge end curve 2-102 passes through the outlet end line 2-103. It can be understood that a pattern of the outlet end line 2-103 can affect a surface pattern of an outlet end of the blade structure 23-100. The outlet end of the blade structure 23-100 is also an air outlet end in actual applications. Accordingly, an end of the blade centerline 23-101 passing through the outlet end line 2-103 is also an air outlet end of the blade centerline 23-101. The positive pressure surface curve Line 2-104 and negative pressure surface curve 2-105 are respectively located on two sides of the blade centerline 23-101. It can be understood that the positive pressure surface curve 2-104 and the negative pressure surface curve 2-105 can be used to affect a curved surface pattern of a positive pressure side and a curved surface pattern of a negative pressure side of the blade structure 23-100 respectively, and two ends of the positive pressure surface curve 2-104 and two ends of the negative pressure surface curve 2-105 are respectively connected to the leading edge end curve 2-102 and the outlet end line 2-103, and thus the leading edge end curve 2-102, the outlet end line 2-103, the positive pressure surface curve 2-104 and the negative pressure surface curve 2-105 can be used to enclose the cross-sectional contour of the blade structure 23-100. In some embodiments, the positive pressure surface curve 2-104 and the negative pressure surface curve 2-105 are both streamlined curves, to be capable of reducing resistances of a positive pressure side and a negative pressure side of the blade structure 23-100 to flowing of gas. Therefore, it is advantageous to improving a driving efficiency of blades for the gas, and in turn further enhancing a efficiency of the fan. An energy consumption of the fan can be saved. An air volume and static pressure of the fan can be increased. A performance of use of the fan can be improved.

In some embodiments, a cross-sectional contour of the blade structure 23-100 may further include: an outlet transition line 2-106 connected between the outlet end line 2-103 and the positive pressure surface curve 2-104. The outlet transition line 2-106 may be an arc line.

In some embodiments, the cross-sectional contour of the blade structure 23-100 may further include an outlet transition line 2-106 connected between the outlet end line 2-103 and the positive pressure surface curve 2-104, and thus the outlet transition line 2-106 can be used to join the outlet end line 2-103 and the positive pressure surface curve 2-104. The outlet transition line 2-106 may be an arc line, to be further capable of ensuring a transition smoothness between the outlet end line 2-103 and the positive pressure surface curve 2-104, preventing an air outlet end of the blade structure 23-100 from generating severe noises due to a sharp angle, enhancing an airflow guide effect of a positive pressure side, which is close to the air outlet end, of the blade structure 23-100. A gas flowing rate on a positive pressure side at an outlet end of the blade structure 23-100 can be improved. It is conducive to mitigating a stress concentration phenomenon at an air outlet end of the blade structure 23-100. A service life of the blade structure 23-100 can be extended. A repair and maintenance cost of the blade structure 23-100 can be reduced.

It can be understood that, in a condition that the cross-sectional contour of the blade structure 23-100 may include the outlet transition line 2-106, the cross-sectional contour of the blade structure 23-100 may be enclosed by the leading edge end curve 2-102, the outlet end line 2-103, the outlet transition line 2-106, the positive pressure surface curve 2-104 and the negative pressure surface curve 2-105.

It can be understood that the outlet transition line 2-106 and the positive pressure surface curve 2-104 can be smoothly connected therebetween, to improve a curvature continuity at a junction of the outlet transition line 2-106 and the positive pressure surface curve 2-104, to be advantageous to reducing a loss of the gas flowing rate of the blade structure 23-100.

As shown in FIG. 7, in some embodiments, a distance from the positive pressure surface curve 2-104 to the blade centerline 23-101 and a distance from the negative pressure surface curve 2-105 to the blade centerline 23-101 may be the same.

In some embodiments, a distance from the positive pressure surface curve 2-104 to the blade centerline 23-101 may be disposed to be the same as a distance from the negative pressure surface curve 2-105 to the blade centerline 23-101, to be capable of improving a symmetry of a thickness distribution of the blade structure 23-100 on two sides of the blade centerline 23-101. It is advantageous to improving a structural strength of the blade structure 23-100. A balance and stability of the blade structure 23-100 in actual applications can be improved. A stress condition of the blade structure 23-100 can be improved. A service life of the blade structure 23-100 can be extended.

It should be noted that in the cross-section of the blade structure 23-100 shown in FIG. 7, a plurality of inscribed circles are drawn that are tangent to the positive pressure surface curve 2-104 and the negative pressure surface curve 2-105 at the same time. Centers of various inscribed circles each are located on the blade centerline 23-101. Diameters of various inscribed circles can be used to characterize a thickness of blade at a position of a corresponding center. Radius of various inscribed circles can be used to characterize a distance from the positive pressure surface curve 2-104 to the blade centerline 23-101 at a position of a corresponding center and a distance from the negative pressure surface curve 2-105 to the blade centerline 23-101 at a position of a corresponding center.

As shown in FIGS. 8 and 9, in some embodiments, an eccentricity e of the blade centerline 23-101 is greater than or equal to 0.3 and less than or equal to 0.6; and/or an air inlet angle β1 of the blade structure 23-100 is greater than or equal to 60° and less than or equal to 85°; and/or the air outlet angle β2 of the blade structure 23-100 is greater than or equal to 140° and less than or equal to 166°; and/or a central angle α of the blade structure 23-100 is greater than or equal to 3° and less than or equal to 6°.

As shown in FIG. 8, in actual applications, since the blade structure 23-100 can be used as a component of the impeller 123-20 of the fan, it can be understood that the impeller 123-20 may generally include a plurality of blades, and thus a plurality of blade structures 23-100 may be disposed at an interval at a hub 23-200 of the impeller 123-20 and disposed in a ring array. In a condition that the plurality of blade structures 23-100 are disposed at the hub 23-200, air inlet ends of blade center lines 23-101 of various blade structures 23-100 are located at a same circumference, and air outlet ends of blade center lines 23-101 of various blade structures 23-100 are located at a same circumference. As shown in FIG. 9, an angle between a tangent at an air inlet end of the blade centerline 23-101 and a circumferential direction is also the air inlet angle 1 of the blade structure 23-100. An angle between a tangent at the air outlet end of the blade centerline 23-101 and a circumferential direction is also the air outlet angle β2 of the blade structure 23-100. As shown in FIG. 8, an angle between a line connecting the air inlet end of the blade centerline 23-101 to an axial line of the hub 23-200 and a line connecting the air outlet end of the blade centerline 23-101 and the axial line of the hub 23-200 is also the central angle α of the blade structure 23-100.

It should be noted that, in order to facilitate a display of the parameters, some blade structures 23-100 in FIG. 8 and FIG. 9 are briefly represented by the blade center lines 23-101.

In some embodiments, parameter ranges of four parameters, namely, the eccentricity e of the blade centerline 23-101, the air inlet angle β1 of the blade structure 23-100, the air outlet angle β2 of the blade structure 23-100, and the central angle α of the blade structure 23-100, are defined. It can be understood that the parameter ranges of the four parameters can all be adopted in actual applications, or one, two or three of the parameter ranges of the four parameters can be adopted arbitrarily. Based on a restriction of the parameter ranges, in actual applications, the impeller 123-20 to which the blade structure 23-100 belongs can be made to provide a higher air volume and static pressure in a high efficiency range. It is advantageous to a performance of the fan. A power consumption of the fan can be reduced. The performance of the fan can be improved. It is also to be conducive to reducing a noise of the fan during use. A user perception of the product can be improved. A user experience of product can be enhanced.

It can be understood that when all the parameter ranges of the above four parameters are adopted, the air volume and static pressure of the fan to which the blade structure 23-100 belongs can be greatly improved, an energy consumption of the fan can be saved, and an operating noise of the fan can be reduced.

It can be understood that in some embodiments, a blade centerline 23-101 of the blade structure 23-100 may be a conic curve. Based on a restriction of the parameter ranges of the above four parameters, it is also convenient to determine curve parameters of the conic curve, and in turn a profiling of the blade structure 23-100 can be guided.

In some embodiments, an eccentricity e of the blade centerline 23-101 may be equal to 0.45; an air inlet angle β1 of the blade structure 23-100 may be equal to 75°; an air outlet angle β2 of the blade structure 23-100 may be equal to 153°; and a central angle α of the blade structure 23-100 may be equal to 4.6°.

As shown in FIG. 7, in some embodiments, a thickness of the blade structure 23-100 increases first and then decreases along a direction from an air inlet end of the blade centerline 23-101 to an air outlet end of the blade centerline 23-101.

In some embodiments, a thickness of the blade structure 23-100 may be set to first increase and then decrease along a direction from an air inlet end of the blade centerline 23-101 to an air outlet end of the blade centerline 23-101, and thus the thickness of the blade structure 23-100 can be changed from the air inlet end to the air outlet end, and in turn a positive pressure side and a negative pressure side of the blade structure 23-100 can be facilitated to present a streamlined structure, and a thickness distribution of the blade structure 23-100 can be made to imitate a thickness distribution of fish to a certain extent. It is advantageous to reducing a gas flowing resistance of the blade structure 23-100 in actual applications, reducing a velocity loss of gas flowing, and improving an efficiency of the fan to which the blade structure 23-100 belongs. An air volume and static pressure of the fan, saving an energy consumption of the fan can be increased. A performance of the fan can be enhanced. Based on the above-mentioned settings, it is also advantageous to reduce a noise of the fan to which the blade structure 23-100 belongs in actual applications and improve a user experience of product.

In some embodiments, along an extension direction of the blade centerline 23-101, a ratio of a distance, which is from a position with maximum thickness of the blade structure 23-100 to an air inlet end of the blade centerline 23-101, to a length of the blade centerline 23-101 may be greater than or equal to 0.2 and less than or equal to 0.4.

In some embodiments, along an extension direction of the blade centerline 23-101, that is, along a direction from the air inlet end of the blade centerline 23-101 to the air outlet end of the blade centerline 23-101, a ratio of a distance, which is from a position with maximum thickness of the blade structure 23-100 to the air inlet end of the blade centerline 23-101, to a length of the blade centerline 23-101 may be set to be greater than or equal to 0.2 and less than or equal to 0.4. It can be understood that, in combination with the foregoing settings along a direction from the air inlet end of the blade centerline 23-101 to the air outlet end of the blade centerline 23-101, the thickness of the blade structure 23-100 first increases and then decreases, so that at a certain position of the blade centerline 23-101, a thickness of the blade structure 23-100 can reach a maximum. Based on the above settings, a position where the maximum thickness of the blade structure 23-100 occurs can be constrained. In actual applications, a resistance of the blade structure 23-100 to a flowing of gas can be further reduced. A velocity loss of flowing of the gas can be reduced. An efficiency of the fan to which the blade structure 23-100 belongs can be improved. An air volume and static pressure of the fan can be increased. An energy consumption of the fan can be saved. A performance of the fan can be enhanced. A noise of the fan to which the blade structure 23-100 belongs can be reduced. A user experience of product can be improved.

In some embodiments, a maximum thickness of the blade structure 23-100 may be greater than or equal to 1 mm and less than or equal to 6 mm, and thus, on the one hand, a thickness of the blade structure 23-100 can be avoided from being too small, to be advantageous to ensuring a strength of the blade structure 23-100 and improving a force-bearing performance of the blade structure 23-100; on another hand, the blade structure 23-100 can also be avoided from being too large. Excessive loads from being generated in actual applications can be prevented. It is conducive to saving an energy consumption of the fan to which the blade structure 23-100 belongs.

As shown in FIGS. 11 to 13, in some embodiments, the impeller 123-20 may include: a hub 23-200; a plurality of blade structures 23-100, which are penetrated through the hub 23-200, the plurality of the blade structures 23-100 being arranged at an interval along a circumferential direction of the hub 23-200; and a hoop 23-300, to which an end of the blade structure 23-100 is connected.

In some embodiments, the impeller 123-20 may include a hub 23-200, a hoop 23-300 and a plurality of blade structures 23-100. The blade structures 23-100 are penetrated through the hub 23-200 and are arranged at an interval along a circumferential direction of the hub 23-200. An end of the blade structure 23-100 is connected to the hoop 23-300 to facilitate using the hoop 23-300 to constrain the ends of the plurality of blade structures 23-100, to improve a stability of the impeller 123-20 during operation. It can be understood that the hub 23-200 can be used to connect to an output shaft of a driving device to drive, when the driving device is running, the hub 23-200 and various blade structures 23-100 to rotate, and thus the blade structures 23-100 can be used to drive a gas to flow to achieve an air supply. The blade structure 23-100 can extend in a form of a conical curve as a whole. A curvature of the blade structure 23-100 can be changed in an extension direction, and thus in a process of gas flowing along the blade structure 23-100, it is more conducive to the blade structure 23-100 to do work on the gas, to facilitate more effectively driving the gas to flow. It is conducive to reducing a gas flowing resistance, and in turn to be capable of improving an efficiency of the fan to which the blade belongs. A power consumption of the fan can be reduced. A static pressure capacity of the fan can be improved. A possibility of fan stall can be reduced. A performance of the fan can be improved. An air volume of the fan can be increased.

In some embodiments, the blade structure 23-100 may be made of plastic material. The plastic material has good processing properties, facilitating controlling a shaping of the blade structure 23-100 during a production process, and being capable of reducing a processing difficulty and processing cost of the blade structure 23-100. The blade structure 23-100 made of plastic material, after being shaped, can also have good structural strength, to be advantageous to saving a material cost while ensuring a service life of the blade structure 23-100.

As shown in FIGS. 11 and 12, in some embodiments, the number of the hoops 23-300 may be two. Two hubs 23-200 are respectively connected to two ends of the blade structure 23-100, to be capable of further enhancing constraints on ends of the blade structure 23-100 and improving a stability and reliability of the impeller 123-20.

In some embodiments, the hoop 23-300, the hub 23-200 and the blade structure 23-100 are an integrated structure.

In some embodiments, the hoop 23-300, hub 23-200 and blade structure 23-100 may be an integrated structure. Therefore, during the impeller 123-20 is processed, the impeller 123-20 can be manufactured by an integrated molding manner. A difficulty of assembling the impeller 123-20 can be reduced. It is advantageous to improving a connection strength among the hoop 23-300, hub 23-200 and blade structure 23-100. A stability of the impeller 123-20 during operation can be further improved. A service life of the impeller 123-20 can be extended. A possibility of loosening among the hoop 23-300, hub 23-200 and blade structure 23-100 can also be reduced. It is advantageous to further reducing a vibration noise of the impeller 123-20 during operation and improving a user experience of product.

As shown in FIG. 13, in some embodiments, the impeller 123-20 may further include: a sleeve 23-400 disposed on the hub 23-200.

In some embodiments, the impeller 123-20 may also include a sleeve 23-400 disposed on the hub 23-200. It can be understood that the sleeve 23-400 is coaxially disposed with the hub 23-200. In actual applications, the hub 23-200 may be interfaced with an output shaft of a driving device through the sleeve 23-400 to receive a power output from the driving device. Based on a disposition of the sleeve 23-400, it is convenient for the impeller 123-20 to be interfaced with the driving device. A convenience of use and operational reliability of the impeller 123-20 can be improved.

In addition, since the impeller 123-20 may include the blade structure 23-100 as described above, the impeller 123-20 has all the advantageous effects of the blade structure 23-100, which will not be elaborated here.

As shown in FIGS. 14 and 15, a fan is provided according to some embodiments of the disclosure, and may include a volute 123-10 and an impeller 123-20. The volute 123-10 forms an air duct. The impeller 123-20 is disposed in the air duct, and can rotate relative to the volute 123-10, and thus during a rotation of the impeller 123-20, an airflow can be delivered to the air duct. A gas can be accelerated and pressurized in the air duct under a driving of the impeller 123-20. Therefore, a gas pressure and flow rate output by the fan can be increased. The fan can output an airflow with a certain pressure to an outside to perform air supply operations.

In some embodiments, the fan may further include a driving device, which is used to drive the impeller 123-20 to rotate.

In addition, since the fan provided according to some embodiments of the disclosure may include the impeller 123-20, the fan has all the advantageous effects of the impeller 123-20, which will not be elaborated here.

According to some embodiments of the disclosure, an air conditioner is provided, and may include: a fan provided according to some embodiments of the disclosure.

Since the air conditioner according to some embodiments of the disclosure may include the above-mentioned fan, the air conditioner has all the advantageous effects of the fan, which will not be elaborated here.

In some embodiments, the blade centerline 23-101 of the blade structure 23-100 may be a conic curve. In actual applications, the blade structure 23-100 may be used as a component of the impeller 123-20 of the fan. For example, a plurality of blade structures 23-100 may be installed on the hub 23-200 of the impeller 123-20, to be convenient for various blades to follow a rotation of the hub 23-200, and in turn to be capable of driving a gas to flow to achieve air supply. Based on the above-mentioned settings, in actual applications, since the blade structure 23-100 can extend in a form of a conic curve as a whole, a curvature of the blade structure 23-100 can be changed in an extension direction, and thus in a process of gas flowing along the blade structure 23-100, it is more conducive to the blade structure 23-100 to do work on the gas, to be more conductive on effectively driving the gas to flow, and in turn to be capable of improving an efficiency of the fan to which the blade belongs, reducing a power consumption of the fan, improving a static pressure capacity of the fan, reducing a possibility of fan stall, improving a performance of the fan. In some embodiments, the blade structure 23-100 may be made of plastic material. The plastic material has good processing properties, which makes it easy to control a profiling of the blade structure 23-100 during a production process, and can reduce a processing difficulty and processing cost of the blade structure 23-100. The blade structure 23-100 made of plastic material can also have good structural strength after shaping, to be advantageous to saving a material cost while ensuring a service life of the blade structure 23-100.

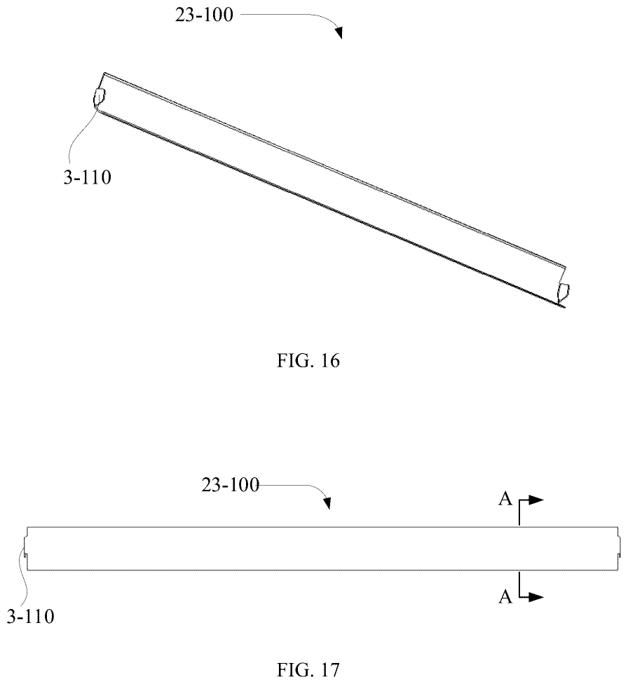

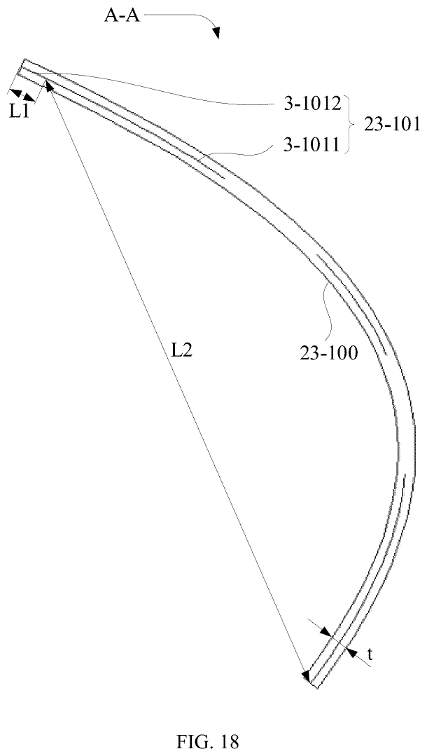

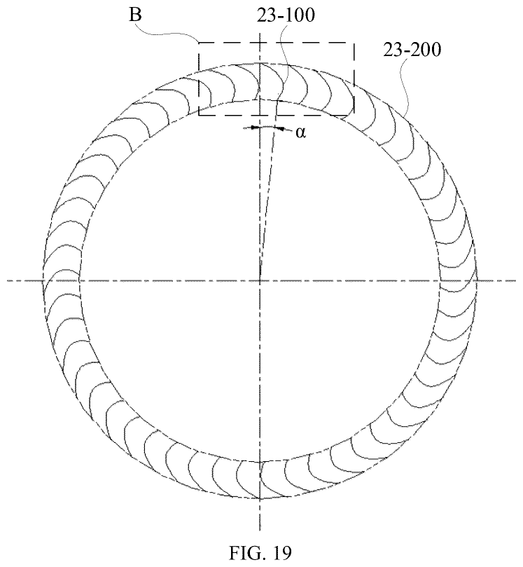

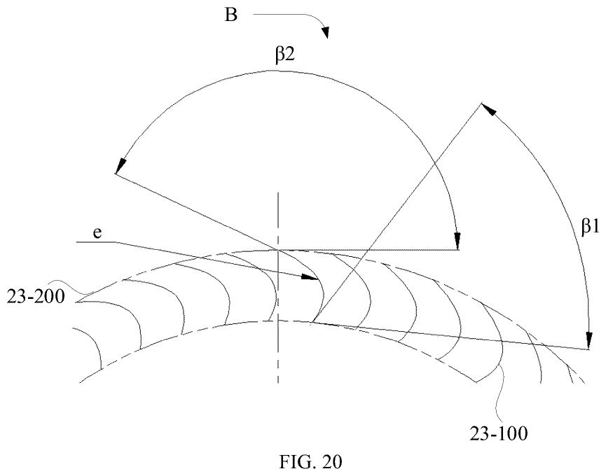

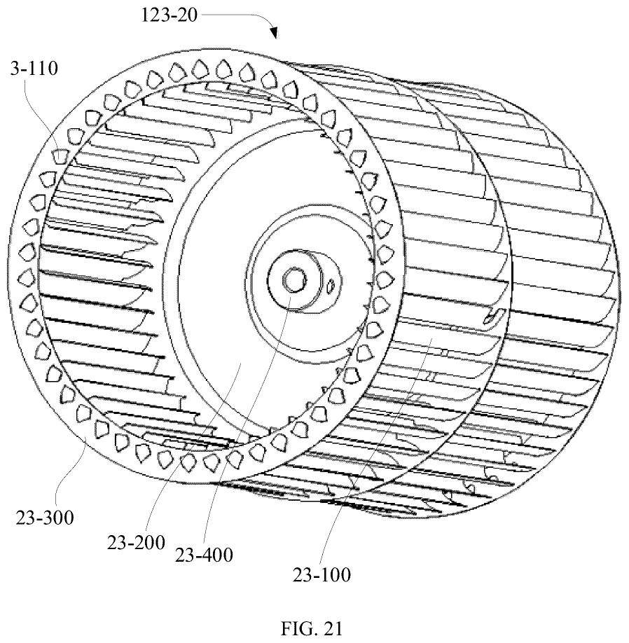

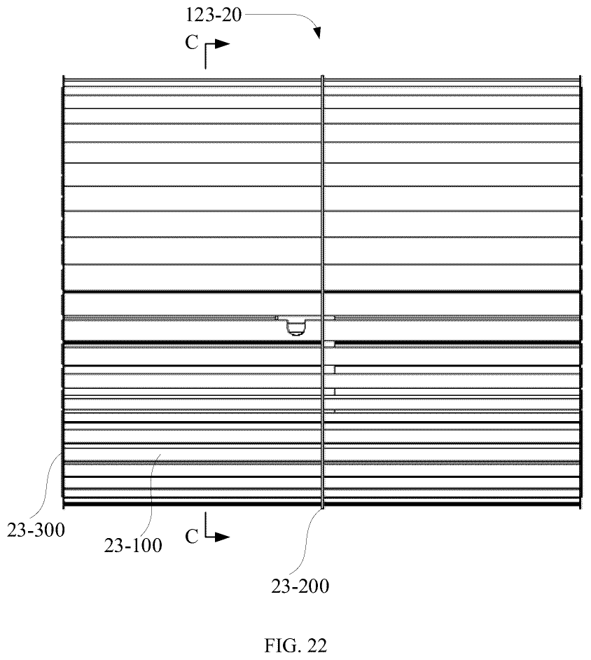

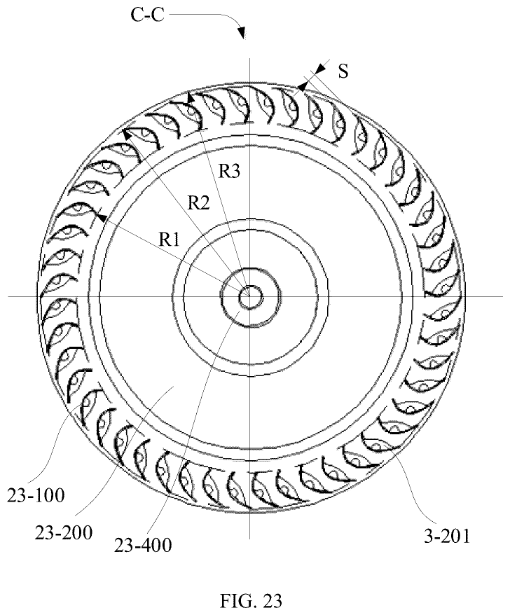

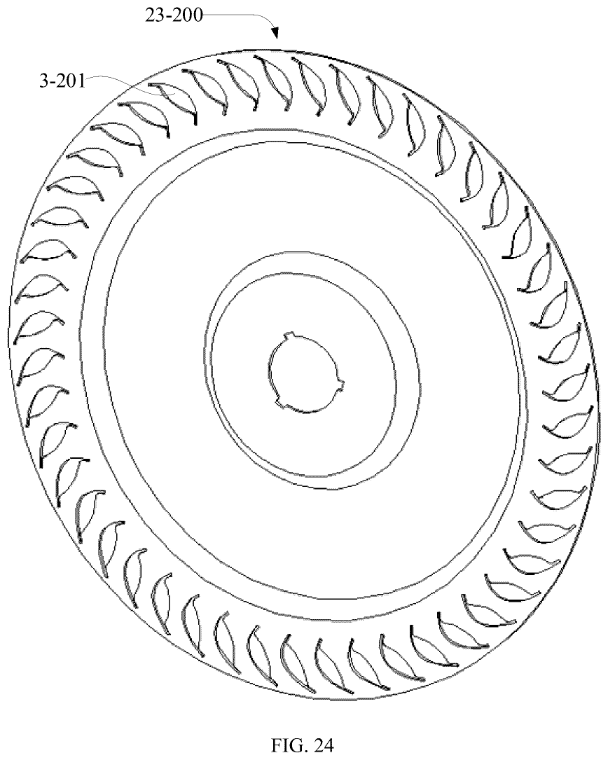

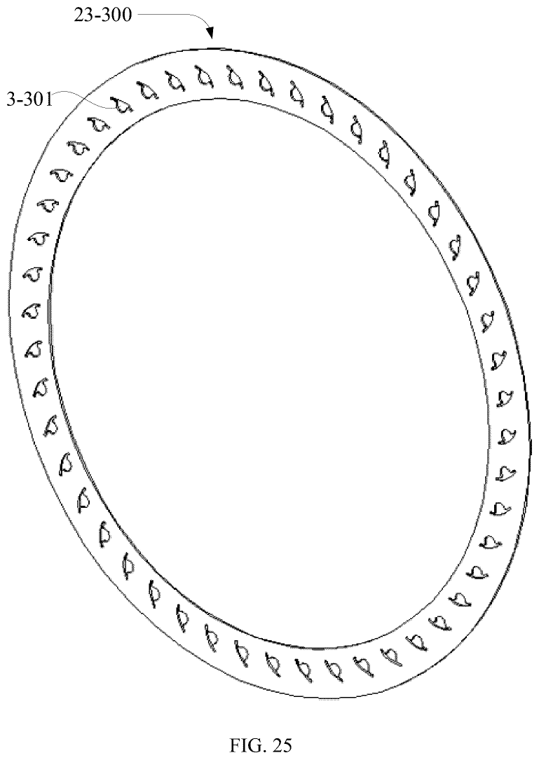

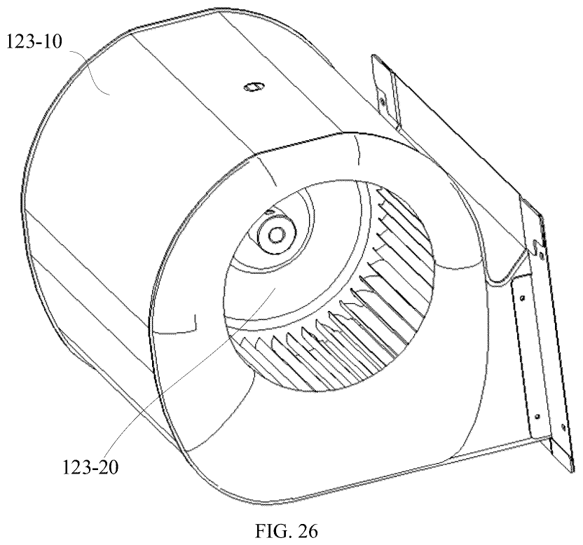

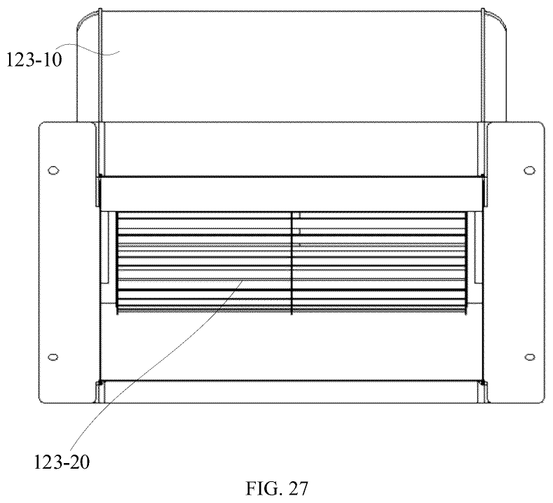

FIG. 16 is a schematic structural diagram of a blade structure from a first viewing angle according to some embodiments of the disclosure; FIG. 17 is a schematic diagram of the blade structure from a second viewing angle according to some embodiments of the disclosure; FIG. 18 is a schematic cross-sectional view of the blade structure taken along A-A direction shown in FIG. 17; FIG. 19 is a schematic diagram of application scenario of the blade structure according to some embodiments of the disclosure; FIG. 20 is a schematic partial enlarged view of a region indicated by B in FIG. 19; FIG. 21 is a schematic structural diagram of an impeller from a first viewing angle according to some embodiments of the disclosure; FIG. 22 is a schematic structural diagram of the impeller from a second viewing angle according to some embodiments of the disclosure; FIG. 23 is a schematic cross-sectional view of the impeller taken along C-C direction shown in FIG. 22; FIG. 24 is a schematic structural diagram of a hub according to some embodiments of the disclosure; FIG. 25 is a schematic structural diagram of a hoop according to some embodiments of the disclosure; FIG. 26 is a schematic structural diagram of a fan from a first viewing angle according to some embodiments of the disclosure; and FIG. 27 is a schematic diagram of the fan from a second viewing angle according to some embodiments of the disclosure.

As shown in FIGS. 16 to 27, the impeller 123-20 of the fan provided according to some embodiments of the disclosure may include a hub 23-200; a blade structure 23-100, which is penetrated through the hub 23-200, and a plurality of the blade structures 23-100 are arranged at an interval along a circumferential direction of the hub 23-200; and a hoop 23-300, to which an end of the blade structure 23-100 is connected.

In some embodiments, the blade structure 23-100 is made of sheet metal. The blade centerline 23-101 of the blade structure 23-100 includes a conic curve segment 3-1011.

In some embodiments, the blade centerline 23-101 of the blade structure 23-100 may include a conic curve segment 3-1011. In actual applications, the blade structure 23-100 may be used as a component of the impeller 123-20 of the fan. For example, a plurality of blade structures 23-100 may be installed on the hub 23-200 of the impeller 123-20, to be convenient for various blades to follow a rotation of the hub 23-200, and in turn to be capable of driving a gas to flow to achieve air supply. In some embodiments, at least a portion of the blade structure 23-100 can extend in a form of a conic curve, and a curvature of the portion of the blade structure 23-100 corresponding to the conic curve segment 3-1011 can be changed in an extension direction, and thus in a process of gas flowing along the blade structure 23-100. It is more conducive to the blade structure 23-100 to do work on the gas, to be conductive to driving the gas to flow. In turn, an efficiency of the fan to which the blade belongs can be improved. A power consumption of the fan, improving a static pressure capacity of the fan can be reduced. A possibility of fan stall can be reduced. A performance of the fan can be improved.

It can be understood that the blade centerline 23-101 of the blade structure 23-100 can also be called a blade profile line. As shown in FIG. 18, according to different usage requirements, a cross-section of the blade structure 23-100 usually extends along a specific curve. This curve is the blade profile line, which is often called the blade centerline 23-101 or the blade profile line. A pattern of the blade centerline 23-101 usually directly affects an efficiency of the fan to which the blade structure 23-100 belongs.

It can be understood that a conic curve generally includes a hyperbola, a parabola or an elliptical arc. The blade centerline 23-101 of the blade structure 23-100 includes a conic curve segment 3-1011, that is, the blade centerline 23-101 of the blade structure 23-100 may include a hyperbola segment or a parabola segment or an elliptical arc segment. If a rectangular coordinate system is established in a cross section of the blade structure 23-100, a general expression of the conic curve segment 3-1011 of the blade centerline 23-101 is as follows:

$$A \cdot {x}^{2} + B \cdot x \cdot y + C \cdot {y}^{2} + D \cdot x + E \cdot y + F = 0 \qquad ( 3 - 1 )$$

In formula (3-1), A, B, C, D, E and F are real numbers, and A≠0, B≠0, C≠0. It is understandable that when B\hat{ }2-4AC<0, the conic curve segment 3-1011 of the blade centerline 23-101 is an elliptical arc segment. When B\hat{ }2-4AC=0, the conic curve segment 3-1011 of the blade centerline 23-101 is a parabolic segment. When B\hat{ }2-4AC>0, the conic curve segment 3-1011 of the blade centerline 23-101 is a hyperbolic segment.

Compared with the blade of fan with a circular-arc blade centerline 23-101, as the blade centerline 23-101 of the blade structure 23-100 may include a conic curve segment 3-1011, on one hand, a curvature of the portion of the blade structure 23-100 corresponding to the conic curve segment 3-1011 can be changed in an extension direction, and thus in a process of gas flowing along the blade structure 23-100, it is more conducive to the blade structure 23-100 to do work on the gas, to be conducive to driving the gas to flow and reducing a gas flowing resistance, and in turn to be capable of improving an efficiency of the fan to which the blade belongs, reducing a power consumption of the fan, improving a static pressure capacity of the fan, reducing a possibility of fan stall, improving a performance of the fan, and increasing an air volume of the fan; on another hand, it can also ensure a higher continuity of curvature of the blade structure 23-100, reduce a velocity loss during use, and be conducive to further increasing a maximum static pressure and air volume of the fan. In some embodiments, by deriving formula (3-1), a formula (3-2) can be obtained:

$$\frac{dy}{dx} = - \frac{2 A \cdot x + C \cdot y + D}{2 B \cdot y + C \cdot x + E} \qquad ( 3 - 2 )$$

It can be seen from formula (3-2) that the blade centerline 23-101 of the blade structure 23-100 can maintain continuous curvature in the conic curve segment 3-1011, and thus, compared with a double-arc or multi-arc blade centerline, this can reduce a velocity loss during use, to be advantageous to further increasing the maximum static pressure and air volume of the fan.

In some embodiments, the blade structure 23-100 may be made of sheet metal parts. The sheet metal parts have good molding accuracy, which makes it easy to control a profiling of the blade structure 23-100 during a production process, to be capable of ensuring a dimensional accuracy of the blade structure 23-100. The blade structure 23-100 which is made of sheet metal parts can also have good structural strength after shaping, to be capable of improving a bearing performance of the blade structure 23-100, and in turn to be conducive to further improving a static pressure and air volume of the fan to which the blade structure 23-100 belongs.

As shown in FIG. 18, in some embodiments, the blade centerline 23-101 may also include: a straight line segment 3-1012 connected to an end of the conic curve segment 3-1011. A smooth transition is provided between the straight line segment 3-1012 and the conic curve segment 3-1011. The straight line segment 3-1012 is close to an air inlet end of the blade structure 23-100. The conic curve segment 3-1011 is close to an air outlet end of the blade structure 23-100.

In some embodiments, the blade centerline 23-101 may also include a straight segment 3-1012 connected to a section of the conic curve segment 3-1011. A smooth transition is provided between the straight segment 3-1012 and the conic curve segment 3-1011, to be capable of avoiding an abrupt curvature change at a junction of the conic curve segment 3-1011 and the straight segment 3-1012. It is advantageous to reducing a gas velocity loss in actual applications. An air volume and static pressure capacity of the fan can be further improved.

It can be understood that two ends of the blade centerline 23-101 correspond to two ends of the blade structure 23-100 respectively. In actual applications, when a blade rotates with the hub 23-200, a gas can flow from an end to another end of the blade structure 23-100, and thus the two ends of the blade structure 23-100 may be regarded as an air inlet end and an air outlet end respectively. Accordingly, an end of the blade centerline 23-101 close to the air inlet end of the blade structure 23-100 may be regarded as an air inlet end of the blade centerline 23-101, and an end of the blade centerline 23-101 close to the air outlet end of the blade structure 23-100 may be regarded as an air outlet end of the blade centerline 23-101. In some embodiments, the straight line segment 3-1012 is close to the air inlet end of the blade structure 23-100, and the conic curve segment 3-1011 is close to the air outlet end of the blade structure 23-100, and thus in actual application, when the blade rotates with the hub 23-200, the gas can flow along a portion of the blade structure 23-100 corresponding to the conic curve segment 3-1011 and a portion of the blade structure 23-100 corresponding to the straight line segment 3-1012 in sequence, and then when the gas flows through the portion of the blade structure 23-100 corresponding to the conic curve segment 3-1011, the gas can be accelerated by working of this portion of the blade structure 23-100 to increase a gas flowing rate, to be advantageous to increasing an air volume of the fan. When the gas flows through the portion of the blade structure 23-100 corresponding to the straight line segment 3-1012, a guide effect of the portion of the blade structure 23-100 is better, and a gas flowing resistance is lower. It is advantageous to a rapid discharge of the airflow. An air supply efficiency of the fan to which the blade structure 23-100 belongs can be improved.

It should be noted that the smooth transition between the straight line segment 3-1012 and the conic curve segment 3-1011 indicates that an extension direction of the straight line segment 3-1012 maintains a high degree of consistency with an extension direction of the conic curve segment 3-1011. It can be understood that the straight line segment 3-1012 is connected to the conic curve segment 3-1011, and thus there is a junction point between the straight line segment 3-1012 and the conic curve segment 3-1011. An angle between a tangent direction of the conic curve segment 3-1011 at the junction point and an extension direction of the straight line segment 3-1012 can be set to be less than or equal to 2°, to ensure a smooth transition between the straight line segment 3-1012 and the conic curve segment 3-1011.

As shown in FIG. 18, in some embodiments, the straight line segment 3-1012 is tangent to the conic curve segment 3-1011.

In some embodiments, the straight line segment 3-1012 may be set to be tangent to the conic curve segment 3-1011, to ensure a smoothness of a transition between the straight line segment 3-1012 and the conic curve segment 3-1011 to a great extent, and reduce an abrupt curvature change in a curvature at a junction of the straight line segment 3-1012 and the conic curve segment 3-1011. In actual applications, a loss of gas flowing rate can be reduced, and an efficiency of the fan to which the blade structure 23-100 belongs can be further improved. A power consumption of the fan can be reduced. A static pressure capacity of the fan can be improved. A performance of the fan can be improved.

As shown in FIG. 18, in some embodiments, a ratio of a length L1 of the straight line segment 3-1012 to a chord length L2 of the conic curve segment 3-1011 is less than or equal to 0.2.

In some embodiments, a ratio of a length L1 of the straight segment 3-1012 to a chord length L2 of the conic curve segment 3-1011 may be set to be less than or equal to 0.2, and thus the length L1 of the straight segment 3-1012 is constrained based on a ratio range of segments to avoid the straight segment 3-1012 being too long, and thus a length of the portion of the blade structure 23-100 corresponding to the straight segment 3-1012 can be shortened. The portion of the blade structure 23-100 corresponding to the straight segment 3-1012 is used to guide a flowing of gas, and at the same time it can be ensured that the gas can quickly leave the blade after flowing through the portion of the blade structure 23-100 corresponding to the conic curve segment 3-1011. Therefore, an external transportation of gas can be realized, A loss of gas along a way cab be reduced. It is conducive to preventing an attenuation of a flowing rate and pressure of the gas, A guarantee can be provided for improving an air volume and static pressure performance of the fan to which the blade structure 23-100 belongs.

As shown in FIGS. 19 and 20, in some embodiments, an eccentricity e of the blade centerline 23-101 is greater than or equal to 0.25 and less than or equal to 0.6; and/or an air inlet angle β1 of a blade body is greater than or equal to 50° and less than or equal to 75°; and/or the air outlet angle β2 of the blade body is greater than or equal to 135° and less than or equal to 170°; and/or a central angle α of the blade body is greater than or equal to 3° and less than or equal to 8°.

As shown in FIG. 19, in some embodiments, since the blade structure 23-100 can be used as a component of the impeller 123-20 of the fan, it can be understood that the impeller 123-20 may generally include a plurality of blades, and thus a plurality of blade structures 23-100 may be disposed at an interval on a hub 23-200 of the impeller 123-20 and disposed in a ring array. In a condition that the plurality of blade structures 23-100 are disposed at the hub 23-200, air inlet ends of blade center lines 23-101 of various blade structures 23-100 are located at a same circumference, and air outlet ends of blade center lines 23-101 of various blade structures 23-100 are located at a same circumference. As shown in FIG. 20, an angle between a tangent at an air inlet end of the blade centerline 23-101 and a circumferential direction is also the air inlet angle 1 of the blade structure 23-100. An angle between a tangent at the air outlet end of the blade centerline 23-101 and a circumferential direction is also the air outlet angle β2 of the blade structure 23-100. As shown in FIG. 19, an angle between a line connecting the air inlet end of the blade centerline 23-101 to an axial line of the hub 23-200 and a line connecting the air outlet end of the blade centerline 23-101 and the axial line of the hub 23-200 is also the central angle α of the blade structure 23-100.

In some embodiments, parameter ranges of four parameters, namely, the eccentricity e of the blade centerline 23-101, the air inlet angle β1 of the blade structure 23-100, the air outlet angle β2 of the blade structure 23-100, and the central angle α of the blade structure 23-100, are limited. It can be understood that the parameter ranges of the four parameters can all be adopted in actual applications, or one, two or three of the parameter ranges of the four parameters can be adopted arbitrarily. Based on a restriction of the parameter ranges, in actual applications, the impeller 123-20 to which the blade structure 23-100 belongs can be made to provide a more higher air volume and static pressure in a high efficiency range, to be advantageous to a performance of the fan, reducing a power consumption of the fan, further to be capable of improving the performance of the fan, and also to be conducive to reducing a noise of the fan during use, improving a user perception of the product, and enhancing a user experience of product.

It can be understood that when all the parameter ranges of the above four parameters are adopted, the air volume and static pressure of the fan to which the blade structure 23-100 belongs can be greatly improved, an energy consumption of the fan can be saved, and an operating noise of the fan can be reduced.

It can be understood that in some embodiments, a blade centerline 23-101 of the blade structure 23-100 may be a conic curve. Based on a restriction of the parameter ranges of the above four parameters, it is also convenient to determine curve parameters of the conic curve, to be capable of guiding a profiling of the blade structure 23-100.

It can be understood that the blade centerline 23-101 includes a conic curve segment 3-1011. A curvature of the conic curve segment 3-1011 can be constrained by limiting a range of the eccentricity e of the blade centerline 23-101.

As shown in FIG. 18, in some embodiments, a thickness of the blade structure 23-100 is uniform along a direction from the air inlet end of the blade structure 23-100 to the air outlet end of the blade structure 23-100.

In some embodiments, a thickness of the blade structure 23-100 may be set to be consistent along a direction from the air inlet end of the blade structure 23-100 to the air outlet end of the blade structure 23-100, to improve a thickness uniformity of the blade structure 23-100 which is made of sheet metal. In actual applications, it is advantageous to improve a stability of the blade structure 23-100 when rotating with the hub 23-200. It can be understood that in actual applications, surfaces of the blade structure 23-100 located on two sides of the blade centerline 23-101 can be regarded as a positive pressure surface and a negative pressure surface, respectively. Based on the above-mentioned settings, the positive pressure surface and negative pressure surface can maintain a high degree of consistency with a pattern of the blade centerline 23-101. It is more conducive for the blade structure 23-100 to do work on the gas. An air volume and static pressure performance of the fan to which the blade structure 23-100 belongs can be improved. An energy consumption of the fan can be reduced.

As shown in FIG. 18, in some embodiments, a ratio of a thickness t of the blade structure 23-100 to a chord length L2 of the conic curve segment 3-1011 is less than or equal to 0.15.

In some embodiments, a ratio of a thickness t of the blade structure 23-100 to a length of a chord length L2 of the conic curve segment 3-1011 may be set to be less than or equal to 0.15, to be capable of avoiding the thickness t of the blade structure 23-100 being too large, to be advantageous to reducing a weight of the blade structure 23-100. In actual applications, it is advantageous to reduce an energy consumption for driving the blade structure 23-100. Therefore, a power consumption of the fan can be further reduced. A material usage of the blade structure 23-100 can be saved. A volume of the blade structure 23-100 can be reduced. A processing difficulty and processing cost of the blade structure 23-100 can be reduced.

As shown in FIGS. 21 to 25, the fan provided according to some embodiments of the disclosure may include an impeller 123-20. The impeller 123-20 may include a hub 23-200, a hoop 23-300 and a plurality of blade structures 23-100. The blade structures 23-100 are penetrated through the hub 23-200 and are arranged at an interval along a circumferential direction of the hub 23-200. An end of the blade structure 23-100 is connected to the hoop 23-300 to facilitate using the hoop 23-300 to constrain the ends of the plurality of blade structures 23-100, to be capable of improving a stability of the impeller 123-20 during operation. It can be understood that the hub 23-200 can be used to connect to an output shaft of a driving device to drive the hub 23-200 and various blade structures 23-100 to rotate when the driving device is running, and thus the blade structures 23-100 can be used to drive a gas to flow to achieve an air supply. At least a portion of the blade structure 23-100 can extend in a form of a conic curve. A curvature of the portion of the blade structure 23-100 corresponding to the conic curve segment 3-1011 can be changed in an extension direction, and thus in a process of gas flowing along the blade structure 23-100, it is more conducive to the blade structure 23-100 to do work on the gas. It is conducive to driving the gas to flow, and in turn to be capable of improving an efficiency of the fan to which the blade belongs. A power consumption of the fan can be reduced. A static pressure capacity of the fan can be improved. A possibility of fan stall can be reduced. A performance of the fan can be improved.

In some embodiments, the blade structure 23-100 may be made of sheet metal parts. The sheet metal parts have good molding accuracy, which makes it easy to control a profiling of the blade structure 23-100 during a production process, to be capable of ensuring a dimensional accuracy of the blade structure 23-100. The blade structure 23-100 which is made of sheet metal parts can also have good structural strength after shaping, to be capable of improving a bearing performance of the blade structure 23-100, and in turn to be conducive to further improving a static pressure and air volume of the fan to which the blade structure 23-100 belongs.

Exemplarily, as shown in FIG. 23 and FIG. 24, the hub 23-200 may be formed with a first mounting hole 3-201. The blade structure 23-100 may be penetrated through the hub 23-200 through the first mounting hole 3-201.

As shown in FIG. 16, FIG. 17, FIG. 21 and FIG. 10, in some embodiments, a fastening structure 3-110 is formed at an end of the blade structure 23-100 connected to the hoop 23-300. The blade structure 23-100 is connected to the hoop 23-300 through the fastening structure 3-110.

In some embodiments, a fastening structure 3-110 may be formed at an end of the blade structure 23-100 for connecting to the hoop 23-300. The blade structure 23-100 may be connected to the hoop 23-300 through the fastening structure 3-110. Based on the above setting, a connection strength between the blade structure 23-100 and the hoop 23-300 can be improved, and a possibility of the blade structure 23-100 loosening from the hoop 23-300 can be reduced. A more reliable guarantee for a stable and smooth operation of the impeller 123-20 can be provided. The fastening structure 3-110 can improve a tightness of connection between the blade structure 23-100 and the hoop 23-300, to be advantageous to reducing a vibration noise of the fan during rotation.

Exemplarily, as shown in FIGS. 16, 17 and 21, the fastening structure 3-110 may be a fastening lap ear. As shown in FIG. 25, the hoop 23-300 can be formed with a second mounting hole 3-301. An end of the blade structure 23-100 can be penetrated through the hoop 23-300 through the second mounting hole 3-301. The fastening lap ear can be snapped at the second mounting hole 3-301 of the hoop 23-300 to improve a tightness of a connection between the blade structure 23-100 and the hub 23-200.

As shown in FIGS. 21 and 22, in some embodiments, the number of the hoops 23-300 may be two. Two hubs 23-200 are respectively connected to two ends of the blade structure 23-100, to be capable of further enhancing end constraints of the blade structure 23-100 and improving a stability and reliability of the impeller 123-20. Correspondingly, two ends of the blade structure 23-100 may be formed with fastening structures 3-110 to be interfaced with the hub 23-200.

In some embodiments, a distance R1 from the air inlet end of the blade structure 23-100 to an axial line of the hub 23-200 is greater than or equal to 75 mm and less than or equal to 180 mm; a distance R2 from the air outlet end of the blade structure 23-100 to the axial line of the hub 23-200 is greater than or equal to 90 mm and less than or equal to 230 mm; a distance from the air outlet end of the blade structure 23-100 to an outer edge of the hub 23-200 is less than or equal to 5 mm; and a distance R2 from the air outlet end of the blade structure 23-100 to the axial line of the hub 23-200 is less than or equal to a radius R3 of the hub 23-200.

In some embodiments, by limiting a range of a distance R1 from the air inlet end of the blade structure 23-100 to an axial line of the hub 23-200 and a distance R2 from the air outlet end of the blade structure 23-100 to the axial line of the hub 23-200, a distribution range of the blade structure 23-100 on the hub 23-200 can be constrained, and a relatively long gas flowing channel can be formed between adjacent blade structures 23-100, and thus in actual applications, the blade structure 23-100 can be used to do work on the gas, to accelerate the gas flow and increase an air volume and pressure. By setting a distance R2 from the air outlet end of the blade structure 23-100 to an outer edge of the hub 23-200 to be less than or equal to 5 mm, and setting a distance R2 from the air outlet end of the blade structure 23-100 to the axial line of the hub 23-200 to be less than or equal to a radius R3 of the hub 23-200, blades can be prevented from being convex outward relative to the hub 23-200 along a radial direction of the hub 23-200. On the one hand, it is convenient for a subsequent assembly of the fan in a housing of the fan and reduces a possibility of structural interference during an assembly process. On another hand, it can also prevent the blade structure 23-100 from colliding with an external structure during a rotation of the impeller 123-20. It is advantageous to reducing a possibility of damage to the blade structure 23-100. A repair and maintenance cost of the impeller 123-20 can be reduced.

As shown in FIG. 23, in some embodiments, a distance S between two adjacent blade structures 23-100 is greater than or equal to 6 mm and less than or equal to 20 mm.

In some embodiments, a distance S between two adjacent blade structures 23-100 may be set to be greater than or equal to 6 mm and less than or equal to 20 mm. Based on the above setting, on the one hand, it is possible to avoid a spacing between two adjacent blade structures 23-100 being too small, and a relatively large gas flowing channel can be formed between the adjacent blade structures 23-100, to reduce a resistance of the gas when flowing through the blade structure 23-100, to be advantageous to increasing an air volume and static pressure of the fan to which the impeller 123-20 belongs, and reducing an energy consumption of the fan; on another hand, in a condition that the structural dimension of the hub 23-200 is determined, the total number of blade structures 23-100 disposed on the hub 23-200 can be constrained based on a restriction of the distance S, to avoid the blade structures 23-100 being too many or too few. This is advantageous for ensuring an output air volume of the impeller 123-20 while preventing the impeller 123-20 from being too heavy due to an excessive number of blade structures 23-100. This can improve a lightweight level of the impeller 123-20, and further save an energy consumption when the impeller 123-20 is driven to rotate. It is advantageous for further improving an efficiency of the fan to which the impeller 123-20 belongs.

As shown in FIG. 21 and FIG. 23, in some embodiments, the impeller 123-20 may further include: a sleeve 23-400 disposed on the hub 23-200.

In some embodiments, the impeller 123-20 may also include a sleeve 23-400 disposed on the hub 23-200. It can be understood that the sleeve 23-400 is coaxially disposed with the hub 23-200. In actual applications, the hub 23-200 may be interfaced with an output shaft of a driving device through the sleeve 23-400 to receive a power output from the driving device. Based on a disposition of the sleeve 23-400, it is convenient for the impeller 123-20 to be interfaced with the driving device. A convenience of use and operational reliability of the impeller 123-20 can be improved.

In addition, in some embodiments, since the impeller 123-20 may include the blade structure 23-100 as described above, the impeller 123-20 has all the advantageous effects of the blade structure 23-100, which will not be elaborated here.

As shown in FIGS. 26 and 27, a fan is provided according to some embodiments of the disclosure, which may include a volute 123-10 and an impeller 123-20. The volute 123-10 forms an air duct. The impeller 123-20 is disposed in the air duct, and can rotate relative to the volute 123-10, and thus during a rotation of the impeller 123-20, an airflow can be delivered to the air duct. A gas can be accelerated and pressurized in the air duct under a driving of the impeller 123-20. Therefore, c a gas pressure and flow rate output by the fan can be increased, and thus the fan can output an airflow with a certain pressure to an outside to perform air supply operations.

In some embodiments, the fan may further include a driving device, which is used to drive the impeller 123-20 to rotate.

In addition, since the fan provided according to some embodiments of the disclosure may include the impeller 123-20, the fan has all the advantageous effects of the impeller 123-20, which will not be elaborated here.

In some embodiments, the blade centerline 23-101 of the blade structure 23-100 may include a conic curve segment 3-1011. In actual applications, the blade structure 23-100 may be used as a component of the impeller 123-20 of the fan. For example, a plurality of blade structures 23-100 may be installed on the hub 23-200 of the impeller 123-20, to be convenient for various blades to follow a rotation of the hub 23-200, and in turn to be capable of driving a gas to flow to achieve air supply. Based on the above setting, since at least a portion of the blade structure 23-100 can extend in a form of a conic curve, a curvature of the portion of the blade structure 23-100 corresponding to the conic curve segment 3-1011 can be changed in an extension direction, and thus in a process of gas flowing along the blade structure 23-100, it is more conducive to the blade structure 23-100 to do work on the gas, to be conductive to driving the gas to flow, and in turn to be capable of improving an efficiency of the fan to which the blade belongs, reducing a power consumption of the fan, improving a static pressure capacity of the fan, reducing a possibility of fan stall, improving a performance of the fan. The blade structure 23-100 may be made of sheet metal parts. The sheet metal parts have good molding accuracy, which makes it easy to control a profiling of the blade structure 23-100 during a production process, to be capable of ensuring a dimensional accuracy of the blade structure 23-100. The blade structure 23-100 which is made of sheet metal parts can also have good structural strength after shaping, to be capable of improving a bearing performance of the blade structure 23-100, and in turn to be conducive to further improving a static pressure and air volume of the fan to which the blade structure 23-100 belongs.

According to some embodiments of the disclosure, an air conditioner is provided, which include: a fan provided according to some embodiments of the disclosure.

Since the air conditioner provided in some embodiments of the disclosure may include the fan provided in some embodiments of the disclosure, the air conditioner has all the advantageous effects of the fan, which will not be elaborated here.

In the disclosure, the terms “first”, “second” and “third” are used for descriptive purposes only and should not be understood as indicating or implying relative importance; the term “plurality” refers to two or more, unless otherwise explicitly defined. The terms “installed”, “connected”, “connected”, “fixed” and the like should be understood in a broad sense. For example, “connection” can be a fixed connection, a detachable connection, or an integral connection; “connected” can be a direct connection or an indirect connection through an intermediate medium. For those skilled in the art, the specific meanings of the above terms in the embodiments of the disclosure can be understood according to specific circumstances.

In the description of the disclosure, it should be understood that the directions or positional relationships indicated by the terms “up”, “down”, “left”, “right”, “front”, “back”, etc. are based on the directions or positional relationships shown in the accompanying drawings, and are only for the convenience of describing the disclosure and simplifying the description, rather than indicating or implying that the device or unit referred to must have a specific direction, be constructed and operated in a specific orientation, and therefore, should not be understood as a limitation on the disclosure.

In the description of this specification, the terms “one embodiment”, “some embodiments”, “specific embodiments”, etc. mean that the specific features, structures, materials or characteristics described in conjunction with the embodiment or example are included in at least one embodiment or example of the disclosure. In this specification, the exemplary expressions of the above terms do not necessarily refer to the same embodiment or example. Furthermore, the specific features, structures, materials, or characteristics described may be combined in any suitable manner in any one or more embodiments or examples.

The above are only preferred embodiments of the disclosure and are not intended to limit the disclosure. For those skilled in the art, the disclosure may have various modifications and changes. Any modifications, equivalent substitutions, improvements, etc. made within the spirit and principles of this disclosure should be included in the protection scope of this application.

1.-35. (canceled)

36. A volute comprising:
an enclosing plate enclosing an air duct; and
an end plate connected to an end of the enclosing plate, the end plate being formed with an air inlet and a convex surface arranged around the air inlet;
wherein the convex surface is located at a side of the end plate away from the air duct, and extends from the enclosing plate toward the air inlet.

37. The volute according to claim 36, wherein:
the end plate includes:
a first guide section, an end of the first guide section being connected to the enclosing plate, and another end of the first guide section extending toward the air inlet, and a first curved surface section being formed at a side of the first guide section away from the air duct; and
a second guide section connected to the first guide section, the air inlet being formed at the second guide section, a second curved surface section being formed at a side of the second guide section away from the air duct, and the second curved surface section extending toward an inner side of the enclosing plate; and
the convex surface includes the first curved surface section and the second curved surface section.

38. The volute according to claim 37, wherein:
the end plate further includes a transition section connected between the first guide section and the second guide section, a transition curved surface section being formed at a side of the transition section away from the air duct, two ends of the transition curved surface section being respectively connected to the first curved surface section and the second curved surface section, and the first curved surface section and the second curved surface section each smoothly transitioning to the transition curved surface section; and
the convex surface further comprises the transition curved surface section.

39. The volute according to claim 38, wherein a ratio of a chord height to a chord length of each curved surface section is less than or equal to 0.5.

40. The volute according to claim 36, further comprising:
an air outlet guide, formed with an air outlet and an air outlet channel that are in communication with each other;
wherein the enclosing plate is formed with an exhaust port that is in communication with the air duct, and the air outlet guide is disposed at the exhaust port, the air outlet channel being in communication with the air duct through the exhaust port.

41. The volute according to claim 36, wherein:
the enclosing plate includes at least two first plate-shaped members sequentially connected along a circumferential direction of the air inlet to enclose the air duct;
the end plate includes at least two second plate-shaped members;
each of the at least two first plate-shaped members is connected to one of the at least two second plate-shaped members; and
each of the at least two second plate-shaped members is formed with a notch, and at least two of the at least two second plate-shaped members are connected to make at least two notches interface with each other to form the air inlet.

42. The volute according to claim 36, wherein:
along an extending-through direction of the air inlet, a protrusion height of the convex surface is greater than or equal to 10 mm; or
the enclosing plate and the end plate are an integrated structure.

43. A fan comprising:
the volute according to claim 36; and
an impeller rotatably disposed in the air duct and disposed toward the air inlet.

44. The fan according to claim 43, wherein the impeller includes:
a hub;
a plurality of blade structures arranged at an interval along a circumferential direction of the hub and each penetrating through the hub, the blade structures being made of plastic, and a blade centerline of each of the blade structures being a conic curve; and
a hoop, to which ends of the blade structure are connected.

45. The fan according to claim 44, wherein:
a cross-sectional contour of each of the blade structures includes a leading edge end curve, through which an end of the blade centerline passes; and
a ratio of an arch height of the leading edge end curve to a chord length of the leading edge end curve is greater than or equal to 0.3 and less than or equal to 0.8.

46. The fan according to claim 45, wherein:
the cross-sectional contour of each of the blade structures further includes:
an outlet end line, through which an end of the blade center line away from the leading edge end curve passes;
a positive pressure surface curve located at a side of the blade centerline, two ends of the positive pressure surface curve being respectively connected to the leading edge end curve and the outlet end line; and
a negative pressure surface curve located at another side of the blade centerline, two ends of the negative pressure surface curve being respectively connected to the leading edge end curve and the outlet end line; and
each of the positive pressure surface curve and the negative pressure surface curve is a streamlined curve.

47. The fan according to claim 46, wherein:
the cross-sectional contour of each of the blade structures further includes an outlet transition line connected between the outlet end line and the positive pressure surface curve; and
the outlet transition line is an arc line.

48. The fan according to claim 46, wherein a distance from the positive pressure surface curve to the blade centerline is same as a distance from the negative pressure surface curve to the blade centerline.

49. The fan according to claim 44, wherein:
an eccentricity of the blade centerline is greater than or equal to 0.3 and less than or equal to 0.6; and/or
an air inlet angle of the blade structure is greater than or equal to 60° and less than or equal to 85°; and/or
an air outlet angle of the blade structure is greater than or equal to 140° and less than or equal to 166°; and/or
a central angle of the blade structure is greater than or equal to 3° and less than or equal to 6°.

50. The fan according to claim 44, wherein a thickness of the blade structure increases first and then decreases along a direction from an air inlet end of the blade centerline to an air outlet end of the blade centerline.

51. The fan according to claim 43, wherein the impeller includes:
a hub;
a plurality of blade structures arranged at an interval along a circumferential direction of the hub and each penetrating through the hub, the blade structures being made of sheet metal, and a blade centerline of each of the blade structures including a conic curve segment; and
a hoop, to which ends of the blade structure are connected.

52. The fan according to claim 51, wherein:
the blade centerline further includes a straight line segment connected to an end of the conic curve segment, a smooth transition being provided between the straight line segment and the conic curve segment; and
the straight line segment is close to an air inlet end of the blade structure, the conic curve segment being close to an air outlet end of the blade structure.

53. The fan according to claim 52, wherein:
the straight line segment is tangent to the conic curve segment; or
a ratio of a length of the straight line segment to a chord length of the conic curve segment is less than or equal to 0.2.

54. The fan according to claim 51, wherein:
an eccentricity of the blade centerline is greater than or equal to 0.25 and less than or equal to 0.6; and/or
an air inlet angle of a blade body is greater than or equal to 50° and less than or equal to 75°; and/or
an air outlet angle of the blade body is greater than or equal to 135° and less than or equal to 170°; and/or
a central angle of the blade body is greater than or equal to 3° and less than or equal to 8°; and/or
a thickness of the blade structure is consistent along a direction from the air inlet end of the blade structure to the air outlet end of the blade structure.

55. An air conditioner comprising the fan according to claim 43.
